(19) United States
(12) Patent Application Publication
(10) Pub. No.: US 2023/0094406 A1
(43) Pub. Date: Mar. 30, 2023

(54) LIQUID CRYSTAL POLYESTER, METHOD FOR PRODUCING LIQUID CRYSTAL POLYESTER, RESIN SOLUTION, METAL-CLAD LAMINATE, AND METHOD FOR PRODUCING METAL-CLAD LAMINATE

(71) Applicant: ENEOS CORPORATION, Tokyo (JP)

(72) Inventor: Shinichi KOMATSU, Tokyo (JP)

(73) Assignee: ENEOS CORPORATION, Tokyo (JP)

(21) Appl. No.: 17/799,607

(22) PCT Filed: Feb. 5, 2021
(86) PCT No.: PCT/JP2021/004333

§ 371 Date: Aug. 12, 2022

(30) Foreign Application Priority Data
Feb. 14, 2020 (JP) 2020-023639

(51) Int. Cl. C08G 69/44; C08G 63/60; C08G 63/672; C08G 63/81; C08J 5/18

(52) U.S. Cl. CPC C08G 69/44; C08G 63/605; C08G 63/672; C08G 63/81; C08J 5/18; C08G 2250/00; C08J 2377/12; C08J 2367/04

(57) ABSTRACT

A liquid crystal polyester wherein a linear liquid crystal polymer chain including specific monomers (A) to (C), in which at least one of the monomer (B) and the monomer (C) contains a compound for forming a bent structural unit, and a content of the compound for forming a bent structural unit is 20 to 40% by mol relative to a total molar amount of the monomers (A) to (C), is bonded via a specific monomer (D), and a content proportion of the monomer (D) is 0.01 to 10 mol relative to 100 mol of the total molar amount of the monomers (A) to (C).

### TECHNICAL FIELD

The present invention relates to a liquid crystal polyester, a method for producing a liquid crystal polyester, a resin solution, a metal-clad laminate, and a method for producing a metal-clad laminate.

### BACKGROUND ART

In the technical field of electronics, the use of liquid crystal polyesters having excellent high-frequency characteristics has been attracting attention as materials and the like for substrates. For example, Japanese Unexamined Patent Application Publication No. 2006-88426 (PTL 1) proposes production of a base film for a flexible printed circuit board using a liquid crystal polyester that contains at least one structural unit selected from the group consisting of a structural unit derived from an aromatic diamine and a structural unit derived from an aromatic amine having a phenolic hydroxyl group in an amount of 10 to 35% by mol relative to all the structural units. Note that such a liquid crystal polyester described in PTL 1 is soluble in a solvent and is excellent in processability that enables cast molding and the like. However, even such a liquid crystal polyester described in PTL 1 is still insufficient in terms of lowering a dissipation factor and the like.

In addition, Japanese Unexamined Patent Application Publication No. 2015-44972 (PTL 2) discloses a liquid crystal polymer obtained by copolymerizing (A) a polymerizable monomer selected from the group consisting of dihydroxyterephthalic acid and a reactive derivative thereof and (B) another polymerizable monomer containing an aromatic hydroxycarboxylic acid, an aromatic dicarboxylic acid, and an aromatic diol, wherein the total amount of the polymerizable monomer (A) is 0.01 to 10 parts by mole relative to the total amount 100 parts by mole of the other polymerizable monomer (B). However, in PTL 2, the solubility of the liquid crystal polymer in a solvent is not studied at all.

Meanwhile, in recent years, the full-scale introduction of the 5th Generation Mobile Communication System (hereinafter referred to as “5G”) has been in progress. In high frequency high speed communication devices (millimeter-wave radars for automobiles, antennas for smartphones, and the like) of GHz bands used for the 5G, the higher the frequency, the larger the transmission loss. For this reason, the use of materials having a lower dissipation factors is demanded. Then, from the viewpoint of the use as such a material, the advent of a liquid crystal polyester that makes it possible to achieve a lower dissipation factor while exhibiting such a high processability that the liquid crystal polyester can be dissolved in a solvent has been demanded.

### CITATION LIST

### Patent Literatures

[PTL 1] Japanese Unexamined Patent Application Publication No. 2006-88426
[PTL 2] Japanese Unexamined Patent Application Publication No. 2015-44972

### SUMMARY OF INVENTION

### Technical Problem

The present invention has been made in view of the above-described problems of the conventional techniques, and an object thereof is to provide a liquid crystal polyester that is capable of having a lower dissipation factor while being soluble in a solvent, and a method for producing the same, as well as, a resin solution, a metal-clad laminate and a method for producing a metal-clad laminate that use the liquid crystal polyester.

### Solution to Problem

The present inventors continuously conducted earnest studies in order to achieve the above objective, and consequently have found that it is possible to achieve a liquid crystal polyester that is capable of having a lower dissipation factor while being soluble in a solvent by making a liquid crystal polyester wherein a linear liquid crystal polymer chain comprising monomers (A) to (C) described below, in which at least one of the monomer (B) and the monomer (C) contains a compound for forming a bent structural unit, and a content of the compound for forming a bent structural unit is 20 to 40% by mol relative to a total molar amount of the monomers (A) to (C), is bonded via a monomer (D) described below, and a content proportion of the monomer (D) is 0.01 to 10 mol relative to 100 mol of the total molar amount of the monomers (A) to (C), and have completed the present invention. Note that here, the monomers (A) to (D) are as follows:

[Monomer (A)] a bifunctional aromatic hydroxycarboxylic acid,
[Monomer (B)] a bifunctional aromatic dicarboxylic acid,
[Monomer (C)] at least one compound selected from the group consisting of a bifunctional aromatic diol and a bifunctional aromatic hydroxyamine, and
[Monomer (D)] an aromatic compound having 3 to 8 functional groups of at least one kind selected from the group consisting of a hydroxy group, a carboxy group, and an amino group.

The liquid crystal polyester of the present invention is a liquid crystal polyester wherein

a linear liquid crystal polymer chain comprising the above monomers (A) to (C), in which at least one of the monomer (B) and the monomer (C) contains a compound for forming a bent structural unit, and a content of the compound for forming a bent structural unit is 20 to 40% by mol relative to a total molar amount of the monomers (A) to (C), is bonded via the above monomer (D), and

a content proportion of the monomer (D) is 0.01 to 10 mol relative to 100 mol of the total molar amount of the monomers (A) to (C).

In addition, a method for producing a liquid crystal polyester of the present invention is a method comprising:

polycondensating a raw material mixture comprising the monomers (A) to (D), in which at least one of the monomer (B) and the monomer (C) contains a compound for forming a bent structural unit, a content of the compound for forming a bent structural unit is 20 to 40% by mol relative to a total molar amount of the monomers (A) to (C), and a content proportion of the monomer (D) is 0.1 to 10 mol relative to 100 mol of the total molar amount of the monomers (A) to (C), to obtain a liquid crystal polyester in which a linear liquid crystal polymer chain comprising the monomers (A) to (C) is bonded via the monomer (D).

In both of the liquid crystal polyester of the present invention and the method for producing a liquid crystal polyester of the present invention, it is preferable that

the monomer (A) be at least one compound selected from compounds represented by the following formula (1):

HO—Ar¹—COOH (1)

[in the formula, Ar¹ is a group selected from the group consisting of 1,4-phenylene, 2,6-naphthylene, and 4,4′-biphenylene],

the monomer (B) be at least one compound selected from compounds represented by the following formula (2):

HOOC—Ar²—COOH (2)

[in the formula, Ar² is a group which may have at least one substituent selected from the group consisting of a fluorine atom, a chlorine atom, a bromine atom, a methyl group, an ethyl group, a propyl group, a trifluoromethyl group, and a phenyl group and which is selected from the group consisting of 1,4-phenylene, 1,3-phenylene, 1,4-naphthylene, 1,5-naphthylene, 1,7-naphthylene (also known as: 2,8-naphthylene), 1,3-naphthylene (also known as: 2,4-naphthylene), 1,6-naphthylene (also known as: 2,5-naphthylene), 2,6-naphthylene, 2,7-naphthylene, and groups represented by the following formula (2-1):

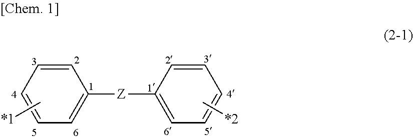

(in the formula, Z is a single bond or a group selected from the group consisting of groups represented by formulae: —O—, —O—(CH₂)₂—O—, —O—(CH₂)₆—O—, —C(CF₃)₂, —CO—, and —SO₂—. Note that bonding arms represented by *1 and *2 are bonding arms bonded to COOH groups in the formula (2).) (In this way, each group that can be selected as Ar² (including the groups represented by the formula (2-1)) may be unsubstituted or may have at least one of the substituents. That is, each group that can be selected as Ar² is an unsubstituted group or a group substituted with at least one of the substituents.).],

the monomer (C) be at least one compound selected from compounds represented by the following formulae (3) to (4):

HO—Ar³—OH (3)

HO—Ar⁴—NH₂ (4)

[in the formula (3), Ar³ is a group which may have at least one substituent selected from the group consisting of a fluorine atom, a chlorine atom, a bromine atom, a methyl group, an ethyl group, a propyl group, a trifluoromethyl group, and a phenyl group and which is selected from the group consisting of 1,4-phenylene, 1,3-phenylene, 1,2-phenylene, 1,2-naphthylene, 1,4-naphthylene, 1,5-naphthylene, 1,7-naphthylene (also known as: 2,8-naphthylene), 1,8-naphthylene, 2,3-naphthylene, 1,3-naphthylene (also known as: 2,4-naphthylene), 1,6-naphthylene (also known as: 2,5-naphthylene), 2,6-naphthylene, 2,7-naphthylene, and groups represented by the following formula (3-1):

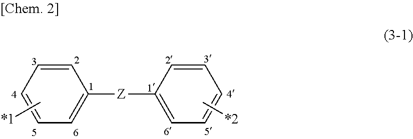

(in the formula, Z is a single bond or a group selected from the group consisting of groups represented by formulae: —O—, —CH₂—, —CH(CH₃)—, —C(CH₃)₂—, —C(CF₃)₂—, —CPh₂-, —CO—, —S—, and —SO₂—. Note that regarding the group represented by the formula: —CPh₂-, Ph represents a phenyl group. In addition, bonding arms represented by *1 and *2 are bonding arms bonded to OH groups in the formula (3).) (In this way, each group that can be selected as Ar³ (including the groups represented by the formula (3-1)) may be unsubstituted or may have at least one of the substituents. That is, each group that can be selected as Ar³ may be an unsubstituted group or a group substituted with at least one of the substituents.), and

in the formula (4), Ar⁴ is a group which may have at least one substituent selected from the group consisting of a fluorine atom, a chlorine atom, a bromine atom, a methyl group, an ethyl group, a propyl group, a trifluoromethyl group, and a phenyl group and which is selected from the group consisting of 1,4-phenylene, 1,3-phenylene, 3,3′-biphenylene, 4,4′-biphenylene, 1,4-naphthylene, 1,5-naphthylene, 1,7-naphthylene, 2,8-naphthylene, 1,3-naphthylene, 2,4-naphthylene, 1,6-naphthylene, 2,5-naphthylene, 2,6-naphthylene, and 2,7-naphthylene (In this way, each group that can be selected as Ar⁴ may be unsubstituted or may have at least one of the substituents. That is, each group that can be selected as Ar⁴ is an unsubstituted group or a group substituted with at least one of the substituents.).], and

the compound for forming a bent structural unit be at least one compound selected from the group consisting of

compounds represented by the formula (2) wherein Ar² is a group which may have at least one substituent selected from the group consisting of a fluorine atom, a chlorine atom, a bromine atom, a methyl group, an ethyl group, a propyl group, a trifluoromethyl group, and a phenyl group and which is selected from the group consisting of 1,3-phenylene, 1,7-naphthylene (also known as: 2,8-naphthylene), 1,3-naphthylene (also known as: 2,4-naphthylene), 1,6-naphthylene (also known as: 2,5-naphthylene), groups represented by the formula (2-1) wherein the Z is a single bond and bonding arms represented by *1 and *2 are bonded to 3,4′ positions, 3,3′ positions, 3,2′ positions, or 2,2′ positions, and groups represented by the formula (2-1) wherein the Z is one selected from the group consisting of groups represented by formulae: —O—, —O—(CH₂)₂—O—, —O—(CH₂)₆—O—, —C(CF₃)₂—, —CO—, and —SO₂—;

compounds represented by the formula (3) wherein Ar³ is a group which may have at least one substituent selected from the group consisting of a fluorine atom, a chlorine atom, a bromine atom, a methyl group, an ethyl group, a propyl group, a trifluoromethyl group, and a phenyl group and which is selected from the group consisting of 1,3-phenylene, 1,2-phenylene, 1,2-naphthylene, 1,7-naphthylene (also known as: 2,8-naphthylene), 1,8-naphthylene, 2,3-naphthylene, 1,3-naphthylene (also known as: 2,4-naphthylene), 1,6-naphthylene (also known as: 2,5-naphthylene), 2,7-naphthylene, groups represented by the formula (3-1) wherein the Z is a single bond and bonding arms represented by *1 and *2 are bonded to 3,4′ positions, 3,3′ positions, 3,2′ positions, or 2,2′ positions, and groups represented by the formula (3-1) wherein the Z is one selected from the group consisting of groups represented by formulae: —O—, —CH₂—, —CH(CH₃)—, —C(CH₃)₂—, —C(CF₃)₂—, —CPh₂-, —CO—, —S—, and —SO₂—; and

compounds represented by the formula (4) wherein Ar⁴ is a group which may have at least one substituent selected from the group consisting of a fluorine atom, a chlorine atom, a bromine atom, a methyl group, an ethyl group, a propyl group, a trifluoromethyl group, and a phenyl group and which is selected from the group consisting of 1,3-phenylene, 1,7-naphthylene, 2,8-naphthylene, 1,3-naphthylene, 2,4-naphthylene, 1,6-naphthylene, 2,5-naphthylene, and 2,7-naphthylene.

In addition, in the above liquid crystal polyester of the present invention, it is preferable that the content proportion of the monomer (D) be 0.1 to 5 mol relative to 100 mol of the total molar amount of the monomers (A) to (C).

### Advantageous Effects of Invention

The present invention makes it possible to provide a liquid crystal polyester that is capable of having a lower dissipation factor while being soluble in a solvent, and a method for producing the same, as well as, a resin solution, a metal-clad laminate and a method for producing a metal-clad laminate that use the liquid crystal polyester.

### BRIEF DESCRIPTION OF DRAWINGS

FIG. 1 is a graph of an infrared absorption spectrum (IR spectrum) of a liquid crystal polyester obtained in Example 1.

FIG. 2 is a graph of a chromatogram (GPC spectrum) obtained by conducting measurement on a resin solution (NMP solution) of the liquid crystal polyester obtained in Example 1 by means of a gel permeation chromatography (GPC) method.

### DESCRIPTION OF EMBODIMENTS

Hereinafter, the present invention will be described in detail based on preferred embodiments.

<Liquid Crystal Polyester>

A liquid crystal polyester of the present invention is a liquid crystal polyester wherein a linear liquid crystal polymer chain comprising the above monomers (A) to (C), in which at least one of the monomer (B) and the monomer (C) contains a compound for forming a bent structural unit, and a content of the compound for forming a bent structural unit is 20 to 40% by mol relative to a total molar amount of the monomers (A) to (C), is bonded via the above monomer (D), and a content proportion of the monomer (D) is 0.01 to 10 mol relative to 100 mol of the total molar amount of the monomers (A) to (C).

[Monomer (A)]

The monomer (A) according to the present invention is a bifunctional aromatic hydroxycarboxylic acid. Such a bifunctional aromatic hydroxycarboxylic acid is not particularly limited, and a publicly-known bifunctional aromatic hydroxycarboxylic acid that can be used for the production of liquid crystal polyesters can be used as appropriate. For example, a compound represented by a formula: HO—Ar—COOH (Ar represents a divalent aromatic group. Note that such a divalent aromatic group may have a substituent) can be used. Note that in an aromatic hydroxycarboxylic acid represented by such a formula: HO—Ar—COOH (wherein Ar represents a divalent aromatic group. Note that such a divalent aromatic group may have a substituent), Ar in the formula includes, for example, a phenylene group, a naphthylene group, a biphenylene group, a terphenylene group and the like each of which may have a substituent. Note that a substituent which a divalent aromatic group as Ar may have is not particularly limited, and includes, for example, a fluorine atom, a chlorine atom, a bromine atom, a methyl group, an ethyl group, a propyl group, a trifluoromethyl group, a phenyl group, and the like.

As such a monomer (A), at least one compound selected from compounds represented by the following formula (1):

HO—Ar¹—COOH (1)

[in the formula, Ar¹ is a group selected from the group consisting of 1,4-phenylene, 2,6-naphthylene, and 4,4′-biphenylene] can be favorably used from the viewpoint that it is possible to efficiently achieve an expression of liquid crystallinity and a reduction in dissipation factor and the viewpoint of easiness of acquisition. Note that as such a compound represented by the formula (1), p-hydroxybenzoic acid and 2-hydroxy-6-naphthoic acid are preferable. In addition, one of such monomers (A) may be used alone or two or more of them may be used in combination.

[Monomer (B)]

The monomer (B) according to the present invention is a bifunctional aromatic dicarboxylic acid. Such a bifunctional aromatic dicarboxylic acid is not particularly limited, and a publicly-known bifunctional aromatic dicarboxylic acid that can be used for the production of liquid crystal polyesters can be used as appropriate. For example, a compound represented by a formula: HOOC—Ar—COOH (Ar represents a divalent aromatic group. Note that the divalent aromatic group may have a substituent) can be used. Note that in an aromatic dicarboxylic acid represented by such a formula: HOOC—Ar—COOH (wherein Ar represents a divalent aromatic group. Note that the divalent aromatic group may have a substituent), Ar has the same meaning as described in the formula of the monomer (A). In addition, in such a monomer (B), Ar in the formula: HOOC—Ar—COOH is not particularly limited, but preferable examples of Ar include, for example, a group selected from groups represented by the following formulae:

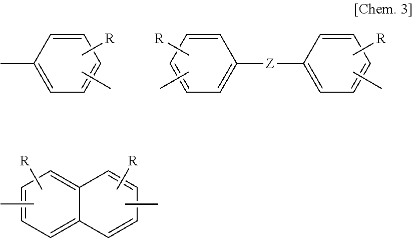

(in the formulae, R are each independently one selected from the group consisting of a hydrogen atom, a fluorine atom, a chlorine atom, a bromine atom, a methyl group, an ethyl group, a propyl group, a trifluoromethyl group, and a phenyl group, and Z is a single bond or a group selected from the group consisting of groups represented by formulae: —O—, —O—(CH₂)₂—O—, —O—(CH₂)₆—O—, —C(CF₃)₂, —CO—, and —SO₂⁻). Note that in the case of a compound in which carboxylic acids are bonded to adjacent carbon atoms in Ar (a divalent aromatic group) (for example, in the case where Ar is a naphthylene, a compound substituted at the 1,2 positions, substituted at the 2,3 positions, or substituted at the 1,8 positions, or the like in which carboxyl acid groups are present adjacent to each other), there is a possibility that conversion to acid dianhydride proceeds in parallel during the production of a liquid crystal polyester depending on employed reaction conditions. For this reason, as the compound represented by the formula: HOOC—Ar—COOH, a compound in which carboxylic acids are not bonded to adjacent carbon atoms in Ar can be more favorably used.

In addition, as such a monomer (B), at least one compound selected from compounds represented by the following formula (2):

HOOC—Ar²—COOH (2)

[Ar² in the formula is a group which may have at least one substituent selected from the group consisting of a fluorine atom, a chlorine atom, a bromine atom, a methyl group, an ethyl group, a propyl group, a trifluoromethyl group, and a phenyl group and which is selected from the group consisting of 1,4-phenylene, 1,3-phenylene, 1,4-naphthylene, 1,5-naphthylene, 1,7-naphthylene (also known as: 2,8-naphthylene), 1,3-naphthylene (also known as: 2,4-naphthylene), 1,6-naphthylene (also known as: 2,5-naphthylene), 2,6-naphthylene, 2,7-naphthylene and groups represented by the formula (2-1)] is preferable, from the viewpoint that it is possible to more efficiently achieve the expression of liquid crystallinity and the reduction in dissipation factor and the viewpoint that it is possible to more improve the solubility in a solvent. Note that as described above, each group that can be selected as Ar² (including the groups represented by the formula (2-1)) may have at least one substituent selected from the group consisting of a fluorine atom, a chlorine atom, a bromine atom, a methyl group, an ethyl group, a propyl group, a trifluoromethyl group, and a phenyl group.

In addition, in the case where the Ar² is a group represented by the formula (2-1), Z in the formula (2-1) is a single bond or a group selected from the group consisting of groups represented by formulae: —O—, —O—(CH₂)₂—O—, —O—(CH₂)₆—O—, —C(CF₃)₂—, —CO—, and —SO₂—. As such Z in the formula (2-1), groups represented by the formulae: —O—, —CO—, and —SO₂— are preferable, and a group represented by the formula: —O— is more preferable because it is possible to achieve higher effects from the viewpoints of a reduction in dissipation factor and an improvement in solubility in a solvent. Moreover, in the case where the Ar² is a group represented by the formula (2-1), as Ar², a group which is represented by the formula (2-1) wherein Z is a single bond, and bonding arms represented by *1 and *2 are bound to the 3,3′ positions or 4,4′ positions (that is, 3,3′-biphenylene, 4,4′-biphenylene) is favorably used because it is possible to achieve higher effects from the viewpoint of a reduction in dissipation factor. In addition, the group selected as the Ar² may have at least one substituent selected from the group consisting of a fluorine atom, a chlorine atom, a bromine atom, a methyl group, an ethyl group, a propyl group, a trifluoromethyl group, and a phenyl group. That is, each group selected as the Ar² may be a group in which a hydrogen atom is substituted with at least one of the substituents. As such a substituent, a methyl group, a phenyl group, and a trifluoromethyl group are more preferable, and a methyl group and a phenyl group are more preferable, because it is possible to achieve higher effects from the viewpoints of a reduction in dissipation factor and an improvement in solubility in a solvent.

In addition, as such a compound represented by the formula (2), terephthalic acid, isophthalic acid, 1,4-naphthalenedicarboxylic acid, 1,5-naphthalenedicarboxylic acid, 2,6-naphthalenedicarboxylic acid, 2,7-naphthalenedicarboxylic acid, and diphenyl ether-4,4′-dicarboxylic acid (also called: 4,4′-dicarboxydiphenyl ether) are more preferable, and terephthalic acid, isophthalic acid, and 2,6-naphthalenedicarboxylic acid are further preferable, from the viewpoints that this makes it possible to more efficiently achieve the expression of liquid crystallinity and the reduction in dissipation factor and the viewpoint that this makes it possible to further improve the solubility in a solvent.

Note that in such a compound represented by the formula (2), the compound for forming a bent structural unit includes compounds represented by the formula (2) wherein Ar² is a group which may have at least one substituent selected from the group consisting of a fluorine atom, a chlorine atom, a bromine atom, a methyl group, an ethyl group, a propyl group, a trifluoromethyl group, and a phenyl group and which is selected from the group consisting of 1,3-phenylene, 1,7-naphthylene (also known as: 2,8-naphthylene), 1,3-naphthylene (also known as: 2,4-naphthylene), 1,6-naphthylene (also known as: 2,5-naphthylene), groups represented by the formula (2-1) wherein the Z is a single bond and bonding arms represented by *1 and *2 are bonded to 3,4′ positions, 3,3′ positions, 3,2′ positions, or 2,2′ positions, and groups represented by the formula (2-1) wherein the Z is one selected from the group consisting of groups represented by formulae: —O—, —O—(CH₂)₂—O—, —O—(CH₂)₆—O—, —C(CF₃)₂—, —CO—, and —SO₂—. Here, the “compound for forming a bent structural unit” refers to, for example, a compound which makes it possible to form not a polymer chain having a straight linear structure but a chain bent by a structure derived from the compound when a structure in a liquid crystal polymer chain is formed using the compound, such as a compound having a structure portion like 1,3-phenylene, and which is used to form a structure portion (structural unit) bent in a polymer chain. On the other hand, in such a compound represented by the formula (2), a compound for forming a structure portion (structural unit) of straight line shape (a compound other than the compound for forming a bent structural unit) includes a compound represented by the formula (2) wherein Ar² is a group which may have at least one substituent selected from the group consisting of a fluorine atom, a chlorine atom, a bromine atom, a methyl group, an ethyl group, a propyl group, a trifluoromethyl group, and a phenyl group and which is selected from the group consisting of 1,4-phenylene, 4,4′-biphenylene, 1,4-naphthylene, 1,5-naphthylene, 2,6-naphthylene, 2,7-naphthylene, and the like.

Among such compounds represented by the formula (2), 2,6-naphthalenedicarboxylic acid, isophthalic acid, terephthalic acid, 4,4′-biphenyl dicarboxylic acid, 1,4-naphthalenedicarboxylic acid, 1,5-naphthalenedicarboxylic acid, 2,7-naphthalenedicarboxylic acid, and 4,4′-dicarboxydiphenyl ether are preferable, 2,6-naphthalenedicarboxylic acid, isophthalic acid, and terephthalic acid are more preferable, 2,6-naphthalenedicarboxylic acid and 4,4′-dicarboxydiphenyl ether are further preferable, and 2,6-naphthalenedicarboxylic acid is particularly preferable, from the viewpoint that it is possible to more efficiently achieve the expression of liquid crystallinity and the reduction in dissipation factor and the viewpoint that it is possible to more improve the solubility in a solvent.

In addition, in a case where at least one of such compounds used as the monomer (B) is used as the compound for forming a bent structural unit, as the compound for forming a bent structural unit, isophthalic acid, 1,7-naphthalenedicarboxylic acid, 1,3-naphthalenedicarboxylic acid, 1,6-naphthalenedicarboxylic acid, and 4,4′-dicarboxydiphenyl ether are preferable, and isophthalic acid is particularly preferable, from the viewpoint that it is possible to more efficiently achieve the expression of liquid crystallinity and the reduction in dissipation factor and the viewpoint that it is possible to more improve the solubility in a solvent.

[Monomer (C)]

The monomer (C) according to the present invention is at least one compound selected from the group consisting of a bifunctional aromatic diol and a bifunctional aromatic hydroxyamine.

Such a bifunctional aromatic diol is not particularly limited, and a publicly-known bifunctional aromatic diol that can be used for the production of liquid crystal polyesters can be used as appropriate. For example, a compound represented by a formula: HO—Ar—OH (Ar represents a divalent aromatic group. Note that the divalent aromatic group may have a substituent.) can be used. Note that in such an aromatic diol represented by the formula: HO—Ar—OH (in the formula, Ar represents a divalent aromatic group. Note that the divalent aromatic group may have a substituent.), Ar has the same meaning as described in the formula of the monomer (A). In addition, in such a monomer (C), Ar in the formula: HO—Ar—OH is not particularly limited, but for example, a group selected from groups represented by the following formulae:

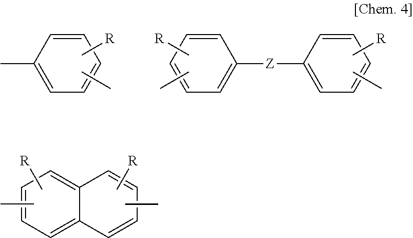

(in the formulae, R are each independently one selected from the group consisting of a hydrogen atom, a fluorine atom, a chlorine atom, a bromine atom, a methyl group, an ethyl group, a propyl group, a trifluoromethyl group, and a phenyl group, and Z is a single bond or a group selected from the group consisting of groups represented by formulae: —O—, —CH₂—, —CH(CH₃)—, —C(CH₃)₂—, —C(CF₃)₂—, —CPh₂-, —CO—, —S—, and —SO₂—) is preferable.

In addition, as such a bifunctional aromatic diol that can be used as the monomer (C), at least one compound selected from compounds represented by the following formula (3):

HO—Ar³—OH (3)

[in the formula, Ar³ is a group which may have at least one substituent selected from the group consisting of a fluorine atom, a chlorine atom, a bromine atom, a methyl group, an ethyl group, a propyl group, a trifluoromethyl group, and a phenyl group and which is selected from the group consisting of 1,4-phenylene, 1,3-phenylene, 1,2-phenylene, 1,2-naphthylene, 1,4-naphthylene, 1,5-naphthylene, 1,7-naphthylene (also known as: 2,8-naphthylene), 1,8-naphthylene, 2,3-naphthylene, 1,3-naphthylene (also known as: 2,4-naphthylene), 1,6-naphthylene (also known as: 2,5-naphthylene), 2,6-naphthylene, 2,7-naphthylene, and groups represented by the formula (3-1)] is preferable, from the viewpoint that it is possible to more efficiently achieve the expression of liquid crystallinity and the reduction in dissipation factor and the viewpoint that it is possible to more improve the solubility in a solvent. Note that as described above, each group (including groups represented by the formula (3-1)) that can be selected as Ar³ may have at least one substituent selected from the group consisting of a fluorine atom, a chlorine atom, a bromine atom, a methyl group, an ethyl group, a propyl group, a trifluoromethyl group, and a phenyl group.

In addition, in the case where the Ar³ is a group represented by the formula (3-1), Z in the formula (3-1) is a single bond or a group selected from the group consisting of groups represented by formulae: —O—, —CH₂—, —CH(CH₃)—, —C(CH₃)₂—, —C(CF₃)₂—, —CPh₂-, —CO—, —S—, and —SO₂—. As such Z in the formula (3-1), a single bond, —O—, and —CO— are preferable, and a single bond and —CO— are more preferable because it is possible to achieve higher effect from the viewpoint of the reduction in dissipation factor and the improvement in solubility in a solvent. Note that as a group represented by the formula (3-1) in the case where Z is a single bond, a group in which bonding arms represented by 1 and *2 are bonded to 2,2′ positions, 3,3′ positions, or 4,4′ positions (that is, 2,2′-biphenylene, 3,3′-biphenylene, or 4,4′-biphenylene) can be preferably used. In addition, each group that can be selected as the Ar³ may have at least one substituent selected from the group consisting of a fluorine atom, a chlorine atom, a bromine atom, a methyl group, an ethyl group, a propyl group, a trifluoromethyl group, and a phenyl group. That is, each group that can be selected as the Ar³ may be a group in which a hydrogen atom is substituted with at least one of the substituents. As such a substituent, a methyl group, phenyl group, trifluoromethyl group are more preferable, and methyl group, phenyl group are more preferable, because it is possible to achieve higher effects from the viewpoints of the reduction in dissipation factor and the improvement in solubility in a solvent.

In addition, as such an aromatic diol, resorcinol, catechol, hydroquinone, 1,2-dihydroxynaphthalene, 1,3-dihydroxynaphthalene, 1,4-dihydroxynaphthalene, 1,5-dihydroxynaphthalene, 1,7-dihydroxynaphthalene, 1,8-dihydroxynaphthalene, 2,3-dihydroxynaphthalene, 1,6-dihydroxynaphthalene, 2,6-dihydroxynaphthalene, 2,7-dihydroxynaphthalene, 1,1′-bi-2-naphthol (BINOL), bisphenol fluorene, biscresol fluorene, methylhydroquinone (MHQ), phenylhydroquinone (PhHQ), 1,4-dihydroxy-2-methylnaphthalene, and 4,4′-biphenol are more preferable, resorcinol, catechol, hydroquinone, 2,3-dihydroxynaphthalene, BINOL, bisphenol fluorene, biscresol fluorene, MHQ, PhHQ, and 4,4′-biphenol are further preferable, and resorcinol, catechol, hydroquinone, 2,3-dihydroxynaphthalene, BINOL, bisphenol fluorene, biscresol fluorene, MHQ, and 4,4′-biphenol are particularly preferable, from the viewpoint that it is possible to more efficiently achieve the expression of liquid crystallinity and the reduction in dissipation factor and the viewpoint that it is possible to more improve the solubility in a solvent.

In addition, the bifunctional aromatic hydroxyamine that is used as the monomer (C) is not particularly limited, and a publicly-known bifunctional aromatic hydroxyamine that can be used for the production of liquid crystal polyesters can be used as appropriate. For example, a compound represented by a formula: HO—Ar—NH₂ (in the formula, Ar represents a divalent aromatic group) can be used. Note that in such an aromatic hydroxyamine represented by the formula: HO—Ar—NH₂ (Ar represents a divalent aromatic group), Ar has the same meaning as described in the formula of the monomer (A). In addition, as Ar in the formula: HO—Ar—NH₂, a group selected from groups represented by

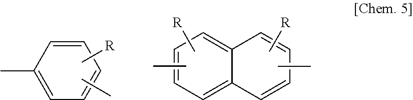

(in the formulae, R are each independently one selected from the group consisting of a hydrogen atom, a fluorine atom, a chlorine atom, a bromine atom, a methyl group, an ethyl group, a propyl group, a trifluoromethyl group, and a phenyl group) is preferable. Note that in the case of a compound in which a hydroxy group and an amino group are bonded to adjacent carbon atoms in Ar (a divalent aromatic group) (for example, in the case where Ar is a naphthylene, a compound substituted at the 1,2 positions, substituted at the 2,3 positions, or substituted at the 1,8 positions, or the like in which a hydroxy group and an amino group are present adjacent to each other), there is a possibility that conversion to oxazole proceeds in parallel depending on employed reaction conditions. For this reason, as the compound represented by the formula: HO—Ar—NH₂, a compound in which a hydroxy group and an amino group are not bonded to adjacent carbon atoms in Ar can be more preferably used.

In addition, as such a bifunctional aromatic hydroxyamine, at least one compound selected from compounds represented by the following formula (4):

HO—Ar⁴—NH₂ (4)

[in the formula, Ar⁴ is a group which may have at least one substituent selected from the group consisting of a fluorine atom, a chlorine atom, a bromine atom, a methyl group, an ethyl group, a propyl group, a trifluoromethyl group, and a phenyl group and which is selected from the group consisting of 1,4-phenylene, 1,3-phenylene, 3,3′-biphenylene, 4,4′-biphenylene, 1,4-naphthylene, 1,5-naphthylene, 1,7-naphthylene, 2,8-naphthylene, 1,3-naphthylene, 2,4-naphthylene, 1,6-naphthylene, 2,5-naphthylene, 2,6-naphthylene, and 2,7-naphthylene] is preferable, from the viewpoint that it is possible to more efficiently achieve the expression of liquid crystallinity and the reduction in dissipation factor and the viewpoint that it is possible to more improve the solubility in a solvent. Note that as described above, each group that can be selected as Ar⁴ may have at least one substituent selected from the group consisting of a fluorine atom, a chlorine atom, a bromine atom, a methyl group, an ethyl group, a propyl group, a trifluoromethyl group, and a phenyl group. That is, each group selected as the Ar⁴ may be a group in which a hydrogen atom is substituted with at least one of the substituents. As such a substituent, methyl group, phenyl group, trifluoromethyl group are more preferable, and methyl group, phenyl group are more preferable, because it is possible to achieve higher effects from the viewpoints of the reduction in dissipation factor and the improvement in solubility in a solvent.

Note that as such a compound represented by the formula (4), 3-aminophenol, 4-aminophenol, 1-amino-3-naphthol (also called: 4-amino-2-naphthol), 1-amino-4-naphthol (also called: 4-amino-1-naphthol), 2-amino-4-naphthol (also called: 3-amino-1-naphthol), 2-amino-6-naphthol (also called: 6-amino-2-naphthol), 2-amino-7-naphthol (7-amino-2-naphthol), 2-amino-8-naphthol (7-amino-1-naphthol), 1-amino-5-naphthol (also called: 5-amino-1-naphthol), 8-amino-2-naphthol (also called: 1-amino-7-naphthol), 6-amino-1-naphthol (also called: 2-amino-5-naphthol), 5-amino-2-naphthol (also called: 1-amino-6-naphthol), 6-methyl-3-aminophenol (6-Me-3-AP), and 3-methyl-4-aminophenol (3-Me-4-AP) are more preferable, 3-aminophenol, 4-aminophenol, 8-amino-2-naphthol, 6-Me-3-AP, and 3-Me-4-AP are further preferable, and 3-aminophenol, 4-aminophenol, and 8-amino-2-naphthol are particularly preferable, from the viewpoint that it is possible to more efficiently achieve the expression of liquid crystallinity and the reduction in dissipation factor and the viewpoint that it is possible to more improve the solubility in a solvent.

Note that in the compound represented by the formula (3) and the compound represented by the formula (4), the compound for forming a bent structural unit includes, for example,

a compound represented by the formula (3) wherein Ar³ in the formula is a group which may have at least one substituent selected from the group consisting of a fluorine atom, a chlorine atom, a bromine atom, a methyl group, an ethyl group, a propyl group, a trifluoromethyl group, and a phenyl group and which is selected from the group consisting of 1,3-phenylene, 1,2-phenylene, 1,2-naphthylene, 1,7-naphthylene (also known as: 2,8-naphthylene), 1,8-naphthylene, 2,3-naphthylene, 1,3-naphthylene (also known as: 2,4-naphthylene), 1,6-naphthylene (also known as: 2,5-naphthylene), 2,7-naphthylene, groups represented by the formula (3-1) wherein the Z is a single bond and bonding arms represented by *1 and *2 are bonded to 3,4′ positions, 3,3′ positions, 3,2′ positions, or 2,2′ positions, and groups represented by the formula (3-1) wherein the Z is one selected from the group consisting of groups represented by formulae: —O—, —CH₂—, —CH(CH₃)—, —C(CH₃)₂—, —C(CF₃)₂—, —CPh₂-, —CO—, —S—, and —SO₂—; and a compound represented by the formula (4) wherein Ar⁴ in the formula is a group which may have at least one substituent selected from the group consisting of a fluorine atom, a chlorine atom, a bromine atom, a methyl group, an ethyl group, a propyl group, a trifluoromethyl group, and a phenyl group and which is selected from the group consisting of 1,3-phenylene, 1,7-naphthylene, 2,8-naphthylene, 1,3-naphthylene, 2,4-naphthylene, 1,6-naphthylene, 2,5-naphthylene, and 2,7-naphthylene. On the other hand, in the compound represented by the formula (3) and the compound represented by the formula (4), a compound for forming a structure portion (structural unit) of a straight line shape (a compound other than the compound for forming a bent structural unit) includes, for example, a compound represented by any formula (each formula) selected from the formula (3) and the formula (4) wherein Ar³ or Ar⁴ in the formula is a group which may have at least one substituent selected from the group consisting of a fluorine atom, a chlorine atom, a bromine atom, a methyl group, an ethyl group, a propyl group, a trifluoromethyl group, and a phenyl group and which is selected from the group consisting of 1,4-phenylene, 4,4′-biphenylene, 1,4-naphthylene, 1,5-naphthylene, 2,6-naphthylene, and groups represented by the formula (3-1) wherein the Z is a single bond and bonding arms represented by *1 and *2 are bonded to 4,4′ positions, 3,5′ positions, or 5,3′ positions.

In addition, as the bifunctional aromatic hydroxyamine, particularly, 3-aminophenol, 4-aminophenol, 1-amino-5-naphthol (also called: 5-amino-1-naphthol), 8-amino-2-naphthol (also called: 1-amino-7-naphthol), 6-amino-1-naphthol (also called: 2-amino-5-naphthol), 5-amino-2-naphthol (also called: 1-amino-6-naphthol), 6-methyl-3-aminophenol (6-Me-3-AP), and 3-methyl-4-aminophenol (3-Me-4-AP) are more preferable, 3-aminophenol, 4-aminophenol, 8-amino-2-naphthol (also called: 1-amino-7-naphthol), 6-amino-1-naphthol (also called: 2-amino-5-naphthol), 5-amino-2-naphthol (also called: 1-amino-6-naphthol), 6-methyl-3-aminophenol (6-Me-3-AP), and 3-methyl-4-aminophenol (3-Me-4-AP) are further preferable, and 3-aminophenol, 4-aminophenol, and 8-amino-2-naphthol (also called: 1-amino-7-naphthol) are particularly preferable, from the viewpoint that it is possible to more efficiently achieve the expression of liquid crystallinity and the reduction in dissipation factor and the viewpoint that it is possible to more improve the solubility in a solvent.

In addition, as the bifunctional aromatic diol, particularly, resorcinol, catechol, hydroquinone, 1,4-dihydroxynaphthalene, 1,5-dihydroxynaphthalene, 1,7-dihydroxynaphthalene, 1,8-dihydroxynaphthalene, 2,3-dihydroxynaphthalene, 1,6-dihydroxynaphthalene, 2,6-dihydroxynaphthalene, 2,7-dihydroxynaphthalene, BINOL, bisphenol fluorene, biscresol fluorene, methylhydroquinone (MHQ), phenylhydroquinone (PhHQ), 1,4-dihydroxy-2-methylnaphthalene, and 4,4′-biphenol are more preferable, resorcinol, catechol, hydroquinone, 2,3-dihydroxynaphthalene, BINOL, bisphenol fluorene, biscresol fluorene, MHQ, PhHQ, and 4,4′-biphenol are further preferable, and resorcinol, catechol, and 2,3-dihydroxynaphthalene are particularly preferable, from the viewpoint that it is possible to more efficiently achieve the expression of liquid crystallinity and the reduction in dissipation factor and the viewpoint that it is possible to more improve the solubility in a solvent.

In addition, in the case where at least one of such compounds used as a monomer (C) is used as the compound for forming a bent structural unit, as the compound for forming a bent structural unit, 3-aminophenol, 1-amino-7-naphthol (also called: 8-amino-2-naphthol), and 6-methyl-3-aminophenol are preferable, and 3-aminophenol and 1-amino-7-naphthol (also called: 8-amino-2-naphthol) are particularly preferable, from the viewpoint that it is possible to more efficiently achieve the expression of liquid crystallinity and the reduction in dissipation factor and the viewpoint that it is possible to more improve the solubility in a solvent.

[Monomer (D)]

The monomer (D) according to the present invention is an aromatic compound having 3 to 8 functional groups of at least one kind selected from the group consisting of a hydroxy group, a carboxy group, and an amino group. In such an aromatic compound having 3 to 8 functional groups, as the functional groups, a hydroxy group and a carboxy group are preferable, because it is possible to achieve higher effects from the viewpoint of the expression of liquid crystallinity, the reduction in dissipation factor, and the solubility in a solvent.

As such a monomer (D), for example, a compound represented by the following general formula (I):

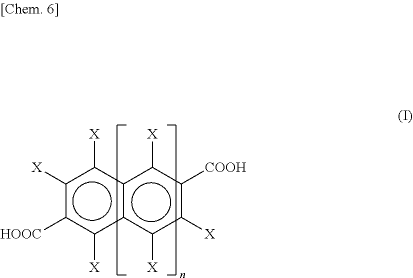

(in the formula, X are each independently a hydroxy group (hydroxyl group), a carboxy group, an amino group, or a hydrogen atom, at least one of the plurality of X represents at least one functional group selected from the group consisting of a hydroxy group, a carboxy group, and an amino group, and n represents an integer of 0 to 2), and

a compound represented by the following general formula (II):

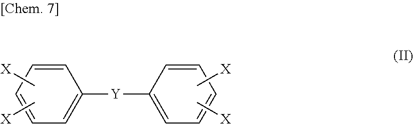

(in the formula, Y is a single bond or a group selected from the group consisting of groups represented by formulae: —O—, —CO—, —S—, —SO₂—, —CH₂—, —C(CH₃)₂—, and —C(CF₃)₂—, X each independently represent a hydroxy group (hydroxyl group), a carboxy group, an amino group, or a hydrogen atom, and at least three of the plurality of X each represent at least one functional group selected from the group consisting of a hydroxy group, a carboxy group, and an amino group) can be preferably used.

In addition, as such an aromatic compound having 3 to 8 functional groups, for example, 2,5-dihydroxyterephthalic acid (2,5-DHTPA), 1,5-dihydroxynaphthalene-2,6-dicarboxylic acid (1,5-DONDC), 1,6-dihydroxynaphthalene-2,5-dicarboxylic acid, 1,4-dihydroxy-2-naphthoic acid, tetrahydroxyterephthalic acid, 1,3,5-benzenetricarboxylic acid (also called: trimesic acid (1,3,5-BTCA)), 3,5-dihydroxybenzoic acid (also called: α-resorcylic acid (3,5-DHBA)), 1,3,5-trihydroxybenzene (also called: phloroglucinol (1,3,5-BTOH)), benzenetetracarboxylic acid, benzenepentacarboxylic acid, benzenehexacarboxylic acid, naphthalenetricarboxylic acid, naphthalenetetracarboxylic acid, naphthalenepentacarboxylic acid, naphthalenehexacarboxylic acid, naphthaleneheptacarboxylic acid, naphthaleneoctacarboxylic acid, 5-hydroxyisophthalic acid, diaminobenezene dicarboxylic acid, diaminonaphthalene dicarboxylic acid, dihydroxyanthracene dicarboxylic acid, di aminoanthracene dicarboxylic acid, 3,3′-dihydroxybenzidine, 4,6-dihydroxy-1,3-phenylenediamine, 4,4′-sulfonylbis(2-aminophenol), 4,4′-(propane-2,2-diyl)bis(2-aminophenol), 4,4′-(perfluoropropane-2,2-diyl)bis(2-aminophenol), 3,3′,4,4′-tetraaminodiphenyl ether, 5,5′-methylenebis(2-aminobenzoic acid), and the like are preferable.

Among such aromatic compounds having 3 to 8 functional groups, 3,5-dihydroxybenzoic acid, 1,3,5-trihydroxybenzene, 2,5-dihydroxyterephthalic acid, 1,5-dihydroxynaphthalene-2,6-dicarboxylic acid, 1,6-dihydroxynaphthalene-2,5-dicarboxylic acid, 1,4-dihydroxy-2-naphthoic acid, 1,3,5-benzenetricarboxylic acid, 5-hydroxyisophthalic acid, and benzenetetracarboxylic acid are more preferable, 2,5-dihydroxyterephthalic acid, 1,5-dihydroxynaphthalene-2,6-dicarboxylic acid, 1,6-dihydroxynaphthalene-2,5-dicarboxylic acid, 1,4-dihydroxy-2-naphthoic acid, and 1,3,5-benzenetricarboxylic acid are more preferable, 2,5-dihydroxyterephthalic acid, 1,5-dihydroxynaphthalene-2,6-dicarboxylic acid, and 1,6-dihydroxynaphthalene-2,5-dicarboxylic acid are further preferable, and 2,5-dihydroxyterephthalic acid is particularly preferable, because it is possible to obtain higher effects from the viewpoints of the expression of liquid crystallinity, the reduction in dissipation factor, and the solubility in a solvent.

[Linear Liquid Crystal Polymer Chain]

The linear liquid crystal polymer chain according to the present invention is a polymer chain comprising the above monomers (A) to (C). That is, such a linear liquid crystal polymer chain contains a structural unit (i) derived from the above monomer (A), a structural unit (ii) derived from the above monomer (B), and a structural unit (iii) derived from the above monomer (C).

As such a structural unit (i) derived from the above monomer (A), a structural unit represented by the following formula (i):

—O—Ar—CO— (i)

[in the formula, Ar represents a divalent aromatic group (note that it is more preferable that such Ar be identical to Ar¹ in the formula (1)). Note that the divalent aromatic group may have a substituent.] is preferable. In addition, as the structural unit (ii) derived from the above monomer (B), a structural unit represented by the following formula (ii):

—OC—Ar—CO— (ii)

[in the formula, Ar represents a divalent aromatic group (note that it is more preferable that such Ar be identical to Ar² in the formula (2)). Note that the divalent aromatic group may have a substituent.] is preferable. Moreover, as the structural unit (iii) derived from the above monomer (C), structural units represented by the following formula (iii) to (iv):

—O—Ar—O— (iii)

—O—Ar—NH— (iv)

[in each formula, Ar represents a divalent aromatic group (note that it is more preferable that Ar in the formula (iii) be identical to Ar³ in the formula (3), and it is more preferable that Ar in the formula (iv) be identical to Ar⁴ in the formula (4)). Note that the divalent aromatic group may have a substituent] are preferable.

In such a linear liquid crystal polymer chain, the content of the monomer (A) is preferably 20 to 70% by mol, and more preferably 30 to 60% by mol, relative to the total molar amount of the above monomers (A) to (C). When the content of the monomer (A) is within this range, there is a tendency that it is possible to achieve higher effects in terms of the expression of liquid crystallinity, the reduction in dissipation factor, and the solubility in a solvent. In particular, setting the content of the monomer (A) to the lower limit or more makes it possible to more improve the effects such as the expression of liquid crystallinity and the reduction in dissipation factor, while setting the content of the monomer (A) to the upper limit or less makes it possible to more improve the solubility in a solvent.

In addition, in the linear liquid crystal polymer chain, the content of the monomer (B) is preferably 10 to 50% by mol, and more preferably 20 to 40% by mol, relative to the total molar amount of the above monomers (A) to (C). When the content of the monomer (B) is within this range, there is a tendency that it is possible to achieve higher effects in terms of the expression of liquid crystallinity, the reduction in dissipation factor, and the solubility in a solvent. In particular, setting the content of the monomer (B) to the lower limit or more makes it possible to more improve the solubility in a solvent, while setting the content of the monomer (B) to the upper limit or less makes it possible to more improve the liquid crystallinity and the reduction in dissipation factor.

Moreover, in the linear liquid crystal polymer chain, the content of the monomer (C) is preferably 10 to 50% by mol, and more preferably 20 to 40% by mol, relative to the total molar amount of the above monomers (A) to (C). When the content of the monomer (C) is within this range, there is a tendency that it is possible to achieve higher effects in terms of the expression of liquid crystallinity, the reduction in dissipation factor, and the solubility in a solvent. In particular, setting the content of the monomer (C) to the lower limit or more makes it possible to more improve the solubility in a solvent, while setting the content of the monomer (C) to the upper limit or less makes it possible to more improve the expression of liquid crystallinity and the reduction in dissipation factor. Note that in the present invention, the preferable ranges of the contents of the respective structural units derived from the monomers (A) to (C) are the same as the above contents of the monomers (A) to (C).

Furthermore, in such a linear liquid crystal polymer chain, the total amount of the monomers (B) to (C) relative to 100 parts by mass of the monomer (A) is preferably 50 to 200 parts by mass (more preferably 55 to 190 parts by mass, and further preferably 60 to 180). When the total amount of the monomers (B) to (C) is within this range, it becomes possible to more improve the expression of liquid crystallinity, the reduction in dissipation factor, and the solubility in a solvent. In particular, setting the total amount of the monomers (B) to (C) to the lower limit or more makes it possible to more improve the solubility in a solvent, while setting the total amount of the monomers (B) to (C) to the upper limit or less makes it possible to more improve the liquid crystallinity and the reduction in dissipation factor.

In addition, in the linear liquid crystal polymer chain comprising the above monomers (A) to (C), at least one of the monomer (B) and the monomer (C) contains a compound for forming a bent structural unit. In order to satisfy such a condition, for example, the monomer (A), the monomer (B) that contains a compound for forming a bent structural unit, and the monomer (C) that does not contain a compound for forming a bent structural unit may be used in combination, or the monomer (A), the monomer (B) that does not contain a compound for forming a bent structural unit, and the monomer (C) that contains a compound for forming a bent structural unit may be used in combination, or the monomer (A), the monomer (B) that contains a compound for forming a bent structural unit, and the monomer (C) that contains a compound for forming a bent structural unit may be used in combination. In addition, in the case of using the monomer (B) that contains a compound for forming a bent structural unit, the monomer (B) may include only the compound for forming a bent structural unit, or may include the compound for forming a bent structural unit and another compound. Similarly, in the case of using the monomer (C) that contains a compound for forming a bent structural unit, the monomer (C) may include only the compound for forming a bent structural unit, or may include the compound for forming a bent structural unit and another compound.

In this way, by using the compound for forming a bent structural unit as at least one of the “compound contained as the monomer (B)” which the linear liquid crystal polymer chain comprises and the “compound contained as the monomer (C)” which the linear liquid crystal polymer chain comprises, it is possible to cause a structure portion having bending property to be contained in the linear liquid crystal polymer chain, which makes it possible to express the liquid crystallinity and the solubility in a solvent. Note that as such a compound for forming a bent structural unit, it is possible to favorably use at least one compound selected from the group consisting of compounds represented by the formula (2) wherein Ar² is a group which may have at least one substituent selected from the group consisting of a fluorine atom, a chlorine atom, a bromine atom, a methyl group, an ethyl group, a propyl group, a trifluoromethyl group, and a phenyl group and which is selected from the group consisting of 1,3-phenylene, 1,7-naphthylene (also known as: 2,8-naphthylene), 1,3-naphthylene (also known as: 2,4-naphthylene), and 1,6-naphthylene (also known as: 2,5-naphthylene), groups represented by the formula (2-1) wherein the Z is a single bond and bonding arms represented by *1 and *2 are bonded to 3,4′ positions, 3,3′ positions, 3,2′ positions, or 2,2′ positions, and groups represented by the formula (2-1) wherein the Z is one selected from the group consisting of groups represented by formulae: —O—, —O—(CH₂)₂—O—, —O—(CH₂)₆—O—, —C(CF₃)₂—, —CO—, and —SO₂—; compounds represented by the formula (3) wherein Ar³ is a group which may have at least one substituent selected from the group consisting of a fluorine atom, a chlorine atom, a bromine atom, a methyl group, an ethyl group, a propyl group, a trifluoromethyl group, and a phenyl group and which is selected from the group consisting of a group selected from the group consisting of 1,3-phenylene, 1,2-phenylene, 1,2-naphthylene, 1,7-naphthylene (also known as: 2,8-naphthylene), 1,8-naphthylene, 2,3-naphthylene, 1,3-naphthylene (also known as: 2,4-naphthylene), 1,6-naphthylene (also known as: 2,5-naphthylene), and 2,7-naphthylene (more preferably, a group selected from the group consisting of 1,3-phenylene, 1,7-naphthylene(also known as: 2,8-naphthylene), 1,3-naphthylene(also known as: 2,4-naphthylene), and 1,6-naphthylene(also known as: 2,5-naphthylene)), groups represented by formula (3-1) wherein the Z is a single bond and bonding arms represented by *1 and *2 are bonded to 3,4′ positions, 3,3′ positions, 3,2′ positions, or 2,2′ positions, and groups represented by the formula (3-1) wherein the Z is one selected from the group consisting of groups represented by formulae: —O—, —CH₂—, —CH(CH₃)—, —C(CH₃)₂—, —C(CF₃)₂—, —CPh₂-, —CO—, —S—, and —SO₂—; and compounds represented by the formula (4) wherein Ar⁴ is a group which may have at least one substituent selected from the group consisting of a fluorine atom, a chlorine atom, a bromine atom, a methyl group, an ethyl group, a propyl group, a trifluoromethyl group, and a phenyl group and which is selected from the group consisting of 1,3-phenylene, 1,7-naphthylene, 2,8-naphthylene, 1,3-naphthylene, 2,4-naphthylene, 1,6-naphthylene, 2,5-naphthylene, and 2,7-naphthylene.

In addition, among such compounds for forming a bent structural unit, isophthalic acid (a type of the monomer (B)), diphenyl ether-4,4′-dicarboxylic acid (a type of the monomer (B)), 3-aminophenol (a type of the monomer (C)), 6-methyl-3-aminophenol (a type of the monomer (C)), 1-amino-7-naphthol (also called “8-amino-2-naphthol”: a type of the monomer (C)), resorcinol (a type of the monomer (C)), bisphenol fluorene (a type of the monomer (C)), biscresol fluorene (a type of the monomer (C)), 2,3-dihydroxynaphthalene (a type of the monomer (C)), catechol (a type of the monomer (C)), and BINOL (a type of the monomer (C)) are preferable, isophthalic acid, 3-aminophenol, and 1-amino-7-naphthol (also called “8-amino-2-naphthol”) are more preferable, and 3-aminophenol and 1-amino-7-naphthol (also called “8-amino-2-naphthol”) are particularly preferable, because it is possible to achieve higher effects from the viewpoints of the expression of liquid crystallinity, the reduction in dissipation factor, and the solubility in a solvent.

In addition, in such a linear liquid crystal polymer chain, the content of the compound for forming a bent structural unit is 20 to 40% by mol (more preferably 22 to 38% by mol, and further preferably 24 to 36% by mol) relative to the total molar amount of the above monomers (A) to (C). If the content of such a compound for forming a bent structural unit is less than the lower limit, the solubility in a solvent decreases, while if the content is more than the upper limit, it becomes difficult to cause the liquid crystallinity to be expressed or to achieve the reduction in dissipation factor (to reduce the dissipation factor).

In this way, since the content of the compound for forming a bent structural unit is 20 to 40% by mol relative to the total molar amount of the above monomers (A) to (C), in the linear liquid crystal polymer chain, a monomer unit (structural unit) derived from the compound for forming a bent structural unit is contained in a proportion of 20 to 40% by mol relative to the total amount of the monomer units which form the liquid crystal polymer chain. For this reason, the shape of the liquid crystal polymer chain becomes not a straight line shape but a curved shape that is bent as appropriate, which makes it possible to dissolve the liquid crystal polyester in a solvent, and makes it possible to achieve the reduction in dissipation factor while expressing the liquid crystallinity.

In addition, as such a linear liquid crystal polymer chain comprising the monomers (A) to (C), particularly linear liquid crystal polymer chains formed by combining the monomers as exemplified in the following (1) to (12) are more preferable.

### (Examples of Preferable Combinations of the Monomers (A) to (C))

(1) 2-hydroxy-6-naphthoic acid/2,6-naphthalenedicarboxylic acid/3-aminophenol
(2) 4-hydroxybenzoic acid/2,6-naphthalenedicarboxylic acid/3-aminophenol
(3) 2-hydroxy-6-naphthoic acid/isophthalic acid/4-aminophenol
(4) 2-hydroxy-6-naphthoic acid/isophthalic acid/3-aminophenol
(5) 2-hydroxy-6-naphthoic acid/2,6-naphthalenedicarboxylic acid/1-amino-7-naphthol
(6) 2-hydroxy-6-naphthoic acid/2,6-naphthalenedicarboxylic acid/bisphenol fluorene
(7) 2-hydroxy-6-naphthoic acid/2,6-naphthalenedicarboxylic acid/biscresol fluorene
(8) 2-hydroxy-6-naphthoic acid/2,6-naphthalenedicarboxylic acid/BINOL
(9) 2-hydroxy-6-naphthoic acid/isophthalic acid/1-amino-7-naphthol
(10) 4-hydroxybenzoic acid/2,6-naphthalenedicarboxylic acid/1-amino-7-naphthol
(11) 2-hydroxy-6-naphthoic acid/terephthalic acid/1-amino-7-naphthol
(12) 2-hydroxy-6-naphthoic acid/terephthalic acid/3-aminophenol
(13) 2-hydroxy-6-naphthoic acid/isophthalic acid/methylhydroquinone
(14) 2-hydroxy-6-naphthoic acid/isophthalic acid/phenylhydroquinone
(15) 2-hydroxy-6-naphthoic acid/diphenyl ether-4,4′-dicarboxylic acid/methylhydroquinone
(16) 2-hydroxy-6-naphthoic acid/2,6-naphthalenedicarboxylic acid/6-methyl-3-aminophenol.

[Structure and the like of Liquid Crystal Polyester]

The liquid crystal polyester of the present invention is such that the linear liquid crystal polymer chain is bonded via the monomer (D).

In addition, in such a liquid crystal polyester, a content proportion of the monomer (D) is 0.01 to 10 mol relative to 100 mol of the total molar amount of the monomers (A) to (C). That is, in such a liquid crystal polyester, in the case where the total molar amount of the monomers (A) to (C) is converted to 100 mol, the monomer (D) is contained in a proportion of 0.01 to 10 mol relative to 100 mol (converted value) of the total molar amount of the monomers (A) to (C). If the content proportion of the monomer (D) is less than the lower limit, it becomes difficult to achieve the reduction in dissipation factor, and the pot life (working life) of the resin solution decreases, while if the content proportion of the monomer (D) is more than the upper limit, when the liquid crystal polyester is dissolved in a solvent, the solid component remains, so that high solubility cannot be obtained.

In addition, in the liquid crystal polyester of the present invention, it is necessary to set the content proportion of the monomer (D) (the content proportion of the structural unit derived from the monomer (D)) to 0.01 to 10 mol relative to 100 mol of the total molar amount of the monomers (A) to (C). In a case where the content proportion of the monomer (D) is reduced (for example, in a case where the content proportion of the monomer (D) is set to about 5 mol or less relative to 100 mol of the total molar amount of the monomers (A) to (C)), it is considered that it is possible to make the structure in which the linear liquid crystal polymer chain is bonded via the monomer (D) into a multi-branched structure such as a so-called dendrimer (hyperbranched polymer or starburst polymer), that is, a multi-branched structure in which the center molecule (core) is derived from the monomer (D) and the linear liquid crystal polymer chains become side chains bonded to the core. Note that since the monomer (D) is a polyfunctional monomer, a multi-branched structure can be formed using the monomer (D) as the center molecule depending on the number of functional groups of the monomer (D). In addition, in a case where the content proportion of the monomer (D) is set to be relatively large within the range of 0.01 to 10 mol relative to 100 mol of the total molar amount of the monomers (A) to (C) (for example, in a case where the content proportion of the monomer (D) is set to about 6 mol or more relative to 100 mol of the total molar amount of the monomers (A) to (C)), it is considered that a net-shaped structure can be formed at least partially. Note that the present inventors assume that in a case where the content proportion of the monomer (D) is set to an amount (proportion) exceeding 10 mol relative to 100 mol (converted value) of the total molar amount of the monomers (A) to (C) in the liquid crystal polyester, a net-shaped structure thus formed becomes dense, with which a high solubility in a solvent cannot be achieved.

Here, the content proportion of the monomer (D) relative to 100 mol of the total molar amount of the monomers (A) to (C) is preferably 0.1 to 5 mol, and more preferably 0.5 to 4 mol, from the viewpoint of achieving a lower value for the dissipation factor, and the viewpoint of more improving the solubility. On the other hand, the content proportion of the monomer (D) relative to 100 mol of the total molar amount of the monomers (A) to (C) is preferably 6 to 10 mol, and more preferably 7 to 9 mol, from the viewpoints of more improving the toughness of the resin and the solution stability of the resin solution.

As such a liquid crystal polyester, the number average molecular weight (Mn) is preferably 10000 to 1000000, and more preferably 50000 to 500000, and the weight average molecular weight (Mw) is preferably 20000 to 2000000, and more preferably 100000 to 1000000. In addition, in the liquid crystal polyester, a ratio (Mw/Mn) between the number average molecular weight (Mn) and the weight average molecular weight (Mw) is preferably within a range of 1.0 to 15.0 (more preferably 2.0 to 10.0). In the case where such Mn and Mw are within the above ranges, there is a tendency that it becomes possible to form a film which is more uniform and excellent in strength when produced. Such molecular weights can be measured by a GPC (gel permeation chromatography) analysis. Note that as a specific measuring method, it is possible to employ the same method as the method employed in a method for measuring the number average molecular weights of the liquid crystal polyesters obtained in Examples described below.

In addition, in such a liquid crystal polyester, the total amount of the monomers (A) to (C) which the linear liquid crystal polymer chain comprises is preferably 90.0 to 99.9% by mol, and more preferably 93.0 to 99.4% by mol, relative to the total amount of the monomers (A) to (D). When the total amount of the monomers (A) to (C) (content of the linear liquid crystal polymer chain) is within this range, there is a tendency that the liquid crystal polyester has an excellent balance in terms of the expression of liquid crystallinity, the reduction in dissipation factor, and the solubility in a solvent.

In addition, the shape of such a liquid crystal polyester of the present invention is not particularly limited, and may be, for example, any of various shapes such as a film shape and a powder shape. In addition, the liquid crystal polyester of the present invention may be molded into a molded body having a pellet shape or the like by extrusion molding using the liquid crystal polyester in a powder shape. Note that a molding method into various shapes and a method for obtaining various types of molded bodies, and the like are not particularly limited, and a publicly-known method that can be used for molding and the like of liquid crystal polyesters can be used as appropriate.

In addition, such a liquid crystal polyester of the present invention can be made into one that is soluble in a solvent and has a lower dissipation factor. Note that in the present invention, when 4 g of the liquid crystal polyester is mixed with 16 g of N-methyl-2-pyrrolidone (NMP), followed by heating at 100° C. for 2 hours, if a solid component of the polyester cannot be visually observed, it is determined that the liquid crystal polyester can be dissolved (soluble) in a solvent. Hence, since the liquid crystal polyester of the present invention is soluble in a solvent, it is possible to dissolve the liquid crystal polyester of the present invention in various solvents for use as a resin solution, and this also makes it possible to more improve the workability during molding.

Note that as a solvent in which the liquid crystal polyester of the present invention can be dissolved, an aprotic solvent is preferable, and the solvent is not limited to the above NMP. Such a solvent (preferably, an aprotic solvent) in which the liquid crystal polyester can be dissolved includes, for example, halogen solvents (1-chlorobutane, chlorobenzene, 1,1-dichloroethane, 1,2-dichloroethane, chloroform, 1,1,2,2-tetrachloroethane, and the like), ether solvents (diethyl ether, tetrahydrofuran, 1,4-dioxane, and the like), ketone solvents (acetone, cyclohexanone, and the like), ester solvents (ethyl acetate and the like), lactone solvents (γ-butyrolactone and the like), carbonate solvents (ethylene carbonate, propylene carbonate, and the like), amine solvents (triethylamine, pyridine, and the like), nitrile solvents (benzonitrile, acetonitrile, succinonitrile, and the like), amide solvents (N,N′-dimethylformamide, N,N′-dimethylacetamide, tetramethylurea, 1,3-dimethyl-2-imidazolidinone, N-methyl-2-pyrrolidone (NMP), and the like), nitro solvents (nitromethane, nitrobenzene, and the like), sulfide solvents (dimethyl sulfoxide, sulfolane, and the like), and phosphoric acid solvents (hexamethylphosphoramide, tri-n-butyl phosphate, and the like). Among such solvents, N,N′-dimethylformamide, N,N′-dimethylacetamide, tetramethylurea, 1,3-dimethyl-2-imidazolidinone, or N-methyl-2-pyrrolidone (NMP) is more preferable, and N-methyl-2-pyrrolidone (NMP) is particularly preferable, from the viewpoint that a higher solubility can be achieved.

Note that the liquid crystal polyester of the present invention has liquid crystallinity (optical anisotropy) derived from the linear liquid crystal polymer chain, and the liquid crystallinity can be observed using polarized light microscopy. Here, the linear liquid crystal polymer chain has liquid crystallinity (optical anisotropy) depending on the types of the monomers used, the content of the compound for forming a bent structural unit, and the like. Hence, in the present invention, when it is determined that the liquid crystal polyester finally obtained has liquid crystallinity, it can be determined that the linear polymer chain comprising the monomers (A) to (C) also has liquid crystallinity.

In addition, in a case where the liquid crystal polyester of the present invention has a melting point of 100 to 400° C., the liquid crystal polyester can be made capable of exhibiting an optically anisotropic molten phase after being melted by heating at such temperature. Such a state of optically anisotropic molten phase can be observed using polarized light microscopy.

Moreover, since the liquid crystal polyester of the present invention has properties such as being soluble in a solvent and having a lower dissipation factor, the liquid crystal polyester can be favorably used as a material and the like for forming substrates used in high frequency⋅high speed communication devices (millimeter-wave radars for automobiles, antennas for smartphones, and the like), for example.

The method for producing such a liquid crystal polyester of the present invention is not particularly limited, but it is preferable to employ a method for producing a liquid crystal polyester of the present invention described later.

For this reason, as the liquid crystal polyester of the present invention, polycondensates of raw material compounds described later are preferable.

<Method for Producing Liquid Crystal Polyester>

The method for producing a liquid crystal polyester of the present invention is a method comprising:

polycondensating a raw material mixture comprising the monomers (A) to (D), in which at least one of the monomer (B) and the monomer (C) contains a compound for forming a bent structural unit, a content of the compound for forming a bent structural unit is 20 to 40% by mol relative to a total molar amount of the monomers (A) to (C), and a content proportion of the monomer (D) is 0.1 to 10 mol relative to 100 mol of the total molar amount of the monomers (A) to (C), to obtain a liquid crystal polyester in which a linear liquid crystal polymer chain comprising the monomers (A) to (C) is bonded via the monomer (D).

The raw material mixture used in such a production method comprises the monomers (A) to (D). The monomers (A) to (D) used in such a production method have the same meanings as described in the above liquid crystal polyester of the present invention (the same applies to preferable ones).

In addition, in such a raw material mixture, at least one of the monomer (B) and the monomer (C) contains a compound for forming a bent structural unit. The form of such a raw material mixture is not particularly limited, and may be a combination of the monomer (B) containing a compound for forming a bent structural unit with the other monomers, or may be a combination of the monomer (C) containing a compound for forming a bent structural unit with the other monomers, or may be a combination of the monomer (B) containing a compound for forming a bent structural unit and the monomer (C) containing the compound for forming a bent structural unit with the other monomer. Note that the “compound for forming a bent structural unit” mentioned herein has the same meaning as described in the liquid crystal polyester of the present invention (the same applies to preferable ones).

In addition, in such a raw material mixture, a content of the compound for forming a bent structural unit is 20 to 40% by mol (more preferably 22 to 38% by mol, and further preferably 24 to 36% by mol) relative to a total molar amount of the monomers (A) to (C). If the content of the compound for forming a bent structural unit is less than the lower limit, the solubility in a solvent decreases, while if the compound for forming a bent structural unit is more than the upper limit, it becomes difficult to achieve the expression of liquid crystallinity or the reduction in dissipation factor (to reduce the dissipation factor).

Moreover, in such a raw material mixture, a content proportion of the monomer (D) is 0.01 to 10 mol relative to 100 mol of the total molar amount of the monomers (A) to (C). If the content proportion of the monomer (D) is less than the lower limit, when the raw material mixture is polycondensated, a multi-branched structure portion is not formed, so that a desired dissipation factor cannot be obtained. On the other hand, if the content proportion of the monomer (D) is more than the upper limit, when the raw material mixture is polycondensated, the probability that the monomer (D) comes into contact with the monomers (A) to (C) increases, and a dense net-shaped structure is formed, so that the solubility in a solvent decreases.

In addition, the content proportion of the monomer (D) is more preferably 0.1 to 5 mol (further preferably 0.5 to 4 mol) relative to 100 mol of the total molar amount of the monomers (A) to (C) because it become possible to achieve a better balance in terms of the expression of liquid crystallinity, the reduction in dissipation factor, and the solubility in a solvent. In a case where the content proportion of the monomer (D) in the raw material mixture set to a lower value such that the content proportion becomes 5 mol or less relative to 100 mol of the total molar amount of the monomers (A) to (C), the probability that the monomer (D) comes into contact with the other monomers decreases. Hence, it becomes possible to make a structure in which a linear liquid crystal polyester chain comprising the monomers (A) to (C) is bonded via the monomer (D) as the core into a so-called dendrimer-type structure. On the other hand, the content proportion of the monomer (D) relative to 100 mol of the total molar amount of the monomers (A) to (C) is preferably 6 to 10 mol, and more preferably 7 to 9 mol, from the viewpoint of more improving the toughness of the resin and the solution stability (pot life) of the resin solution.

Moreover, since the content of the monomer (A), the content of the monomer (B), and the content of the monomer (C) in the linear liquid crystal polymer chain in the obtained liquid crystal polyester can be set to within the respective preferable ranges, in the raw material mixture, it is preferable to set the content of the monomer (A) relative to the total molar amount of the monomers (A) to (C) to 20 to 70% by mol (more preferably 30 to 60% by mol), moreover, it is preferable to set the content of the monomer (B) relative to the total molar amount of the monomers (A) to (C) to 10 to 50% by mol (more preferably 20 to 40% by mol), and furthermore it is preferable to set the content of the monomer (C) relative to the total molar amount of the monomers (A) to (C) to 10 to 50% by mol (more preferably 20 to 40% by mol). In addition, it is preferable to set the total amount of the monomers (B) to (C) relative to 100 parts by mass of the monomer (A) to 50 to 200 parts by mass (more preferably 55 to 190 parts by mass, and further preferably 60 to 180).

Moreover, it is preferable that the raw material mixture further contain an acid anhydride from the viewpoint of industrial production method (decarboxylation polymerization). As such an acid anhydride, acetic anhydride, propionic anhydride, butyric anhydride, and isobutyric anhydride are preferable. Among these, acetic anhydride is more preferable from the viewpoint of easiness of removing a condensate (carboxylic acid). Note that the content of such an acid anhydride is preferably 1.00 to 1.20 molar equivalents (more preferably 1.01 to 1.10 molar equivalents) relative to a hydroxyl group and an amino group in all the monomers (monomers (A) to (D)).

In addition, in such a raw material mixture, as necessary, a publicly-known additive component that can be used in polycondensation of polyester such as a catalyst, another monomer, a condensing agent, or an azeotropic solvent may be added as appropriate.

As such a catalyst, a conventionally publicly-known catalyst for polymerizing polyester can be used, and includes, for example, metallic salt catalysts such as magnesium acetate, stannous acetate, tetrabutyl titanate, lead acetate, sodium acetate, potassium acetate, antimony trioxide: organic compound catalysts such as nitrogen-containing heterocyclic compounds such as N-methylimidazole: and the like. The amount of such a catalyst to be used is not particularly limited, but is preferably 0.0001 to 0.1 parts by weight relative to 100 parts by mass of the total amount of the monomers.

In addition, in the present invention, the raw material mixture was polycondensated (reacted). Such a polycondensation method only has to be a method that is capable of obtaining a liquid crystal polyester by reacting and polycondensating functional groups (a hydroxy group, a carboxy group, an amino group, and the like) which the monomers (A) to (D) have, and for example, a publicly-known polycondensation method that is capable of forming an ester bond and/or an amide bond can be used as appropriate.

In addition, in the present invention, when the raw material mixture is polycondensated (reacted), it is preferable to polycondensate the raw material mixture through melt polymerization from the viewpoint that it becomes possible to reduce the number of steps while it is possible to more improve the reaction efficiency and the yield of products. In addition, as reaction conditions for such polycondensation, publicly-known conditions used in formation of liquid crystal polyesters can be employed as appropriate depending on the types of monomers to be used, and is not particularly limited. However, it is preferable to polycondensate the raw material mixture through melt polymerization by reacting the raw material mixture under a temperature condition of 0 to 400° C. (more preferably 100 to 380° C.) for 0.1 to 100 hours.

In such polycondensation, it is preferable to employ a method that first reacts a raw material mixture under a first temperature condition of 100 to 400° C. (more preferably 120 to 380° C.) to form a polymer (prepolymer) having a low degree of polymerization, and then further reacts the raw material mixture under a second temperature condition of 150 to 400° C. (more preferably 160 to 380° C.) to polycondensate the raw material mixture through melt polymerization or solid phase polymerization from the viewpoint of improving the degree of polymerization and the physical properties. The reaction time under the first temperature condition is preferably 0.1 to 50 hours (more preferably 0.5 to 30 hours). In addition, the reaction time under the second temperature condition is preferably 0.5 to 50 hours (more preferably 1.0 to 30 hours). Setting the first and second temperature conditions and the respective reaction times within the above ranges makes it possible to improve the degree of polymerization and the physical properties.

Note that a raw material mixture may be polycondensated using a publicly-known solid phase polymerization method (for example, a method that heat-treat a prepolymer resin under an inert atmosphere of nitrogen or the like or under vacuum at a temperature range of 100 to 400° C. for 1 to 30 hours, or the like) after a prepolymer is obtained through melt polymerization or the like in which the raw material mixture is reacted under the first temperature condition, the prepolymer was cooled down and solidified, thereafter is pulverized into a powder shape or a flake shape.

In addition a polymerization reaction apparatus that can be used in conducting such a polycondensation (preferably, melt polymerization) is not particularly limited, and for example, a publicly-known reaction apparatus used for reacting a high viscosity fluid can be used as appropriate. Such a reaction apparatus includes, for example, stirred tank-type polymerization reaction apparatuses having stirring apparatuses equipped with stirring blades of various shapes of anchor type, multi-stage type, spiral band type, spiral shaft type, and the like, or shapes obtained by modifying these types, or mixing apparatuses such as a kneader, a roll mill, and a Bunbury mixer used for kneading resins, and the like.

In this way, by polycondensating the raw material mixture, it is possible to obtain a liquid crystal polyester in which a linear liquid crystal polymer chain comprising the monomers (A) to (C) is bonded via the monomer (D). The polycondensate of the raw material mixture obtained in this way is favorable one of the liquid crystal polyester of the present invention.

<Resin Solution>

A resin solution of the present invention comprises: the above liquid crystal polyester of the present invention; and a solvent.

The solvent used in such a resin solution (varnish) only has to be a solvent in which a liquid crystal polyester can be dissolved, and is not particularly limited. The above solvents described as those in which the above-described liquid crystal polyester can be dissolved can be used as appropriate. One of such solvents may be used alone or two or more of them may be used as a mixture.

In such a resin solution (varnish), a content of the liquid crystal polyester is not particularly limited, but is preferably 0.1 to 80% by mass (more preferably 1 to 50% by mass). When the content is within the above range, the resin solution (varnish) can be used more favorably as a varnish for producing a resin film (such a resin film may be used as a resin layer stacked on a substrate.) and the like.

In addition, in a case where such a resin solution (varnish) is used as a solution for forming a film, the mass of the solvent is preferably an amount 2 to 100 times the mass of the liquid crystal polyester.

Note that such a resin solution can be favorably used for producing liquid crystal polyesters of various shapes. For example, it is possible to easily produce a liquid crystal polyester having a film shape by applying such a resin solution onto various substrates and curing the resin solution. The method for preparing such a resin solution (varnish) is not particularly limited, and any publicly-known method can be employed as appropriate.

In addition, depending on the usage, such a resin solution may further contain additive components such as antioxidants, ultraviolet absorbers⋅hindered amine light stabilizers, nucleating agents⋅clarifying agents, inorganic fillers (glass fibers, hollow glass spheres, talc, mica, alumina, titania, silica, and the like), heavy metal deactivatorsadditives for filled polymers, flame retardants, processability improvers⋅lubricants/water dispersion type stabilizers, permanent antistatic agents, toughness improvers, surfactants, carbon fibers, and the like, for example.

Such a resin solution makes it possible to efficiently produce liquid crystal polyesters of various shapes (for example, a film and the like). For example, in a case where a film is prepared using the resin solution, it is also possible to efficiently produce a liquid crystal polyester of a film shape by applying the resin solution onto various substrates (for example, a glass substrate, a metal plate, and the like), and removing the solvent from the applied film (for example, removing the solvent through evaporation or the like), followed by heating and curing to form a film. Note that in the case where a film made of such a liquid crystal polyester is formed, the design of the thickness may be changed as appropriate depending on the usage and is not particularly limited, but is preferably around 1 to 1000 μm from the viewpoint of the mechanical properties and the handling. In addition, the method for such application is not particularly limited, but a publicly-known method such as a spin coating method, a roller coating method, a spray coating method, a curtain coating method, a dip coating method, a slot coating method, a dropping method, a gravure printing method, a screen printing method, a relief printing method, a die coating method, a curtain coating method, an inkjet method, or the like can be employed as appropriate, for example. Moreover, the method for removing the solvent from the applied film is also not particularly limited, but a method that heats the applied film while reducing the pressure is preferably employed. As the temperature condition at this time, a temperature equal to or more than the boiling point of the solvent is preferably employed.

<Metal-Clad Laminate>

A metal-clad laminate of the present invention comprises: a metal foil; and a polyester resin layer stacked on the metal foil, wherein the polyester resin layer is a layer made of the above liquid crystal polyester of the present invention.

Such a metal foil is not particularly limited, and a publicly-known metal foil on which the polyester resin layer can be stacked can be used as appropriate. Such a metal foil includes, for example, a copper foil, copper alloy foils of phosphor bronze, red brass, brass, nickel silver, titanium copper, Corson alloy, and the like, a stainless steel foil, an aluminum foil, an iron foil, an iron alloy foil, a nickel foil, a nickel alloy foil, and the like. As such a metal foil, a copper foil is particularly preferable. In addition, such a copper foil may be a rolled copper foil or an electrolytic copper foil, but a rolled copper foil is preferable. In such a copper foil, a roughening treatment may be conducted on a surface onto which a polyester resin layer is to be stacked. Such a roughening treatment can be conducted through a copper-cobalt-nickel alloy plating process, a copper-nickel-phosphorus alloy plating process, or the like as described in Japanese Unexamined Patent Application Publication No. 2014-141736 (JP 2014-141736 A).

In addition, on the surface of the copper foil onto which the polyester resin layer is to be stacked (in a case where a roughening treatment is conducted, the roughened surface), a heat-resistant layer or an anti-rust layer may be formed. The method for forming such a heat-resistant layer or anti-rust layer is not particularly limited, and a publicly-known method (for example, a method such as a nickel plating process described in JP 2014-141736 A) can be employed as appropriate. Moreover, on the surface of the copper foil onto which the polyester resin layer is to be stacked (in a case where a roughening treatment is conducted, the roughened surface, or in a case where a heat-resistant layer or an anti-rust layer is formed, the surfaces of these layers), it is preferable that a surface-treatment layer made of a silane coupling agent containing nitrogen atoms be formed. This further improves adhesion between the copper foil and the polyester resin layer. Such a silane coupling agent containing nitrogen atoms is not particularly limited, and a publicly-known silane coupling agent (for example, a silane coupling agent exemplified in paragraph [0034] of Japanese Unexamined Patent Application Publication No. 2017-071193, and the like) can be used as appropriate.

In addition, as such a copper foil, for example, rolled copper foils in which fine roughening particles are formed in base foils excellent in bending properties such as HA foil, HA-V2 foil, TPC foil (tough pitch foil), HS foil, and surface-treated foil (BHY treatment, BHYX treatment, and GHY5 treatment), manufactured and sold by JX Nippon Mining & Metals Corporation, and electrolytic copper foils (for example, those manufactured by JX Nippon Mining & Metals Corporation under the trade names of JXUT, JTCLC, JTCSLC, JXLP, JXEFL, and the like) can be used. In addition, the thickness of such a copper foil only has to be a thickness that is applicable to a copper-clad laminate, and is not particularly limited.

In addition, in the present invention, the polyester resin layer is stacked on the metal foil. Then, such a polyester resin layer is a layer made of the above liquid crystal polyester of the present invention. The thickness of such a polyester resin layer made of the liquid crystal polyester is not particularly limited, but is preferably 1 to 1000 μm (more preferably 5 to 300 μm). Setting the thickness within the above range makes it possible to achieve a layer having higher uniformity and higher mechanical strength, and there is also a tendency that higher easiness in production like easier removal of the solvent in production of a polyester resin layer using the resin solution is achieved.

Note that since the above liquid crystal polyester of the present invention has a low dissipation factor as described above, it is possible to make more excellent the metal-clad laminate of the present invention comprising such a polyester resin layer in terms of high frequency usage and millimeter-wave radars usage. Note that such a metal-clad laminate of the present invention can be favorably used for, for example, a material (flexible copper-clad laminate (FCCL)) and the like of a flexible printed circuit board (FPC).

<Method for Producing Metal-Clad Laminate>

A method for producing a metal-clad laminate of the present invention is a method comprising: forming an applied film of the above resin solution of the present invention on a surface of a metal foil; and then heating and curing the applied film to obtain a metal-clad laminate.

In such a method for producing a metal-clad laminate, the method for forming an applied film of the resin solution on the metal foil is not particularly limited, and a publicly-known method can be employed as appropriate. For example, a method for forming an applied film of the resin solution on the metal foil by coating the metal foil with the resin solution by employing a publicly-known coating method (a spin coating method, a roller coating method, a spray coating method, a curtain coating method, a dip coating method, a slot coating method, a dropping method, a gravure printing method, a screen printing method, a relief printing method, a die coating method, a curtain coating method, an inkjet method, or the like) may be employed.

In addition, the method for heating and curing such an applied film is also not particularly limited, and a method that can be used in forming a polyester resin layer using a resin solution (varnish) can be employed as appropriate (for example, a method that heats an applied film at a temperature of around 100 to 500° C. for 0.1 to 10 hours to cure the applied film may be employed). Note that before heating and curing the applied film, it is preferable to conduct a step of removing the solvent from the applied film. Such a solvent removing step is also not particularly limited, and can be conducted by setting conditions as appropriate depending on the type of the solvent (for example, a method for removing the solvent from the applied film by leaving the applied film to stand at a temperature condition of 30 to 400° C. for around 0.1 to 100 hours may be employed).

### EXAMPLES

The present invention will be described more specifically below based on Examples and Comparative Examples; however, the present invention is not limited to Examples below.

First, methods for evaluating a liquid crystal polyester obtained in each Example or the like will be described.

<Evaluation of Structure of Liquid Crystal Polyester>

The structure of the liquid crystal polyester obtained in each Example was evaluated by conducting IR spectrometry thereon under a condition of attenuated total reflection (ATR) using a Fourier transform infrared (FT-IR) spectrometer (trade name “NICOLET is10”) manufactured by Thermo SCIENTIFIC and trade name “MicromATR vision” manufactured by Czitek as measuring devices. Note that since in the IR spectrometry, an absorption spectrum near 1700 cm⁻¹ is derived from C═O stretching of an ester or an amide, the liquid crystal polyester for which the presence of C═O stretching of an ester was confirmed by an absorption spectrum near 1700 cm⁻¹ in the IR spectrometry was evaluated such that esterification or the like proceeded due to reaction of monomers so that polyester was formed.

<Evaluation of Liquid Crystallinity of Liquid Crystal Polyester>

Polarized light microscopy was conducted on the liquid crystal polyester obtained in each Example to evaluate the presence or absence of liquid crystallinity. Specifically, the liquid crystal polyester was heated and melted on a microscope hot-stage, and thereafter the presence or absence of optical anisotropy was observed to check liquid crystallinity, using a polarized light microscopy (trade name: “BHS-751-P-100”) manufactured by Olympus and a hot-stage system (HS82) manufactured by Mettler Toledo, and the like.

<Measurement of Number Average Molecular Weight of Liquid Crystal Polyester>

Measurement of GPC (gel permeation chromatography) was conducted on the liquid crystal polyester obtained in each Example to obtain the number average molecular weight (Mn). Specifically, an NMP solution of the liquid crystal polyester (the content of the liquid crystal polyester: 20 wt %) was prepared, one drop of the NMP solution (about 15 mg) was dissolved in 1.0 mL of a GPC eluent (a solution obtained by adding 10 mmol of lithium bromide to 1.0 L of N,N-dimethylacetamide), and analysis was conducted under a condition of a flow speed of 0.5 ml/min using EcoSEC HLC-8320GPC (GPC columns: TOSOH TSKgel super AW 2500×2+TOSOH TSKgel super AW 3000×1+TOSOH TSKgel super AW 4000×1+TOSOH TSKgel guardcolumn super AW-L×1) manufactured by TOSOH. The analysis was conducted using a refractometer (RI) and an ultraviolet analyzer (UV: 275 nm) together as detectors, and the number average molecular weight (Mn) was obtained from RI data.

<Measurement of Melting Point of Liquid Crystal Polyester>

DSC measurement was conducted on the liquid crystal polyester obtained in each Example to measure the melting point. Specifically, the melting point was measured using a differential scanning calorimeter (DSC-7020) manufactured by Seiko Instruments Inc. incompliance with the test methods of ISO 11357 and ASTM D3418. Note that in this measurement, the peak of the endothermic peak obtained by increasing the temperature from room temperature to 300 to 380° C. at a rate of temperature increase of 10° C./min under a nitrogen gas stream (200 mL/min) to completely melt the polymer, thereafter lowering the temperature to 30° C. at a rate of 10° C./min, and further increasing the temperature to 360° C. at a rate of 10° C./min was obtained as the melting point (Tm).

<Evaluation of Solubility of Liquid Crystal Polyester>

First, 4.0 g of the liquid crystal polyester obtained in each Example was mixed with 16.0 g of N-methyl-2-pyrrolidone (NMP), the mixture liquid thus obtained was heated at 100° C. for 2 hours, and thereafter it was visually checked whether or not the solid component of the polyester remained in the mixture liquid. When no solid component remained, the liquid crystal polyester was evaluated to have solubility in a solvent, while when even a small amount of the solid component remained, the liquid crystal polyester was evaluated to have no solubility in a solvent. Note that such an evaluation was conducted together with a step of preparing a resin solution.

<Methods for Measuring Dissipation Factor (Df) and Relative Permittivity (Dk)>

The dissipation factor (Df,tan δ) and the relative permittivity (Dk,εr) were measured by using a sample piece obtained by drying the polyester film (vertical side (length): 76 mm, horizontal side (width): 52 mm, film thickness: 22 μm) obtained in each Example or the like at 85° C. for 2 hours and employing the split post dielectric resonator (SPDR) method. In addition, such a measurement was conducted in a laboratory adjusted to be under an environment of 23° C. and a relative humidity of 50%, and trade name “Vector Network Analyzer PNA-X N5247A” manufactured by Keysight Technologies International Japan G.K. (the former Agilent Technologies Inc.) was used as a measuring device. In addition, in the measurement, the test piece (the polyester film after being dried at 85° C. for 2 hours) was set in the SPDR dielectric resonator which was the measuring device, and the respective actual measured values of the dissipation factor (tan δ) and the relative permittivity (εr) were obtained with the frequency being set to 10 GHz. Such a measurement of the actual measured values was conducted four times in total, average values of these were obtained to obtain the values of the dissipation factor (tan δ) and the relative permittivity (εr) of the polyester film obtained in each Example or the like. In this way, as the values of the dissipation factor (tan δ) and the relative permittivity (εr), the average values of the actual measured values obtained by four times of measurement were employed.

[Raw Material Compounds Used in Each Example or the Like]

Abbreviated names and the like of compounds (monomers) used in Examples and the like are shown below. In the descriptions of Examples and the like below (including Tables), the compounds are expressed using the abbreviated names described below.

<Monomer (A): Bifunctional Aromatic Hydroxycarboxylic Acid>

2,6-HNA: 2-Hydroxy-6-naphthoic acid (produced by Ueno Fine Chemicals Industry, Ltd.)

<Monomer (B): Bifunctional Aromatic Dicarboxylic Acid>

2,6-NDCA: 2,6-Naphthalenedicarboxylic acid (produced by Ueno Fine Chemicals Industry, Ltd.)

IPA: Isophthalic acid (produced by Mitsubishi Gas Chemical Company, Inc.)

DCDPE: Diphenyl ether-4,4′-dicarboxylic acid (produced by Tokyo Chemical Industry Co., Ltd.)

<Monomer (C): Bifunctional Aromatic Hydroxyamine>

3-AP: 3-Aminophenol (produced by Aldrich)

4-AP: 4-Aminophenol (produced by Aldrich)

1,7-ANL: 1-Amino-7-naphthol (produced by Aldrich: 8-amino-2-naphthol)

MHQ: Methylhydroquinone (produced by Seiko Chemical Co., Ltd.)

PhHQ: Phenylhydroquinone (produced by Tokyo Chemical Industry Co., Ltd.)

6Me-3-AP: 6-Methyl-3-aminophenol (produced by Tokyo Chemical Industry Co., Ltd.)

<Monomer (D): Polyfunctional (Tetrafunctional) Aromatic Compound>

2,5-DHTPA: 2,5-Dihydroxyterephthalic acid (produced by Tokyo Chemical Industry Co., Ltd.)

1,5-DONDC: 1,5-Dihydroxynaphthalene-2,6-dicarboxylic acid (produced by Sugai Chemical Industry Co., Ltd.)

1,3,5-BTCA: 1,3,5-Benzenetricarboxylic acid (produced by Tokyo Chemical Industry Co., Ltd.)

5H-IPA: 5-Hydroxyisophthalic acid (produced by Tokyo Chemical Industry Co., Ltd.)

3,5-DHBA: 3,5-Dihydroxybenzoic acid (produced by Tokyo Chemical Industry Co., Ltd.)

1,3,5-BTOH: 1,3,5-Trihydroxybenzene (an anhydride, produced by Tokyo Chemical Industry Co., Ltd.)

Note that all “IPA”, “3-AP”, “1,7-ANL”, “DCDPE”, and “6Me-3-AP” used as the monomer (B) or (C) are compounds for forming a bent structural unit.

### Example 1

<Step of Preparing a Liquid Crystal Polyester>

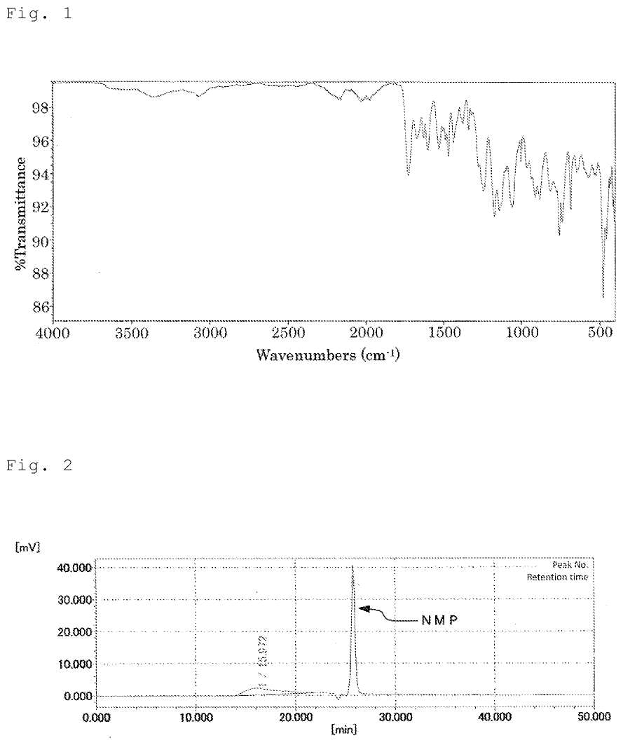

Into a 500-ml separable flask, 2,6-HNA (0.205 mol, 38.59 g), 2,6-NDCA (0.137 mol, 29.56 g), 3-AP (0.137 mol, 14.92 g), 2,5-DHTPA (0.003 mol, 0.68 g), and acetic anhydride (0.482 mol, 49.55 g) were added. Next, the raw material mixture thus obtained was heated at 200° C. for 1 hour to be polycondensated in the separable flask, and then the temperature was increased to 330° C. and the raw material mixture was held at 330° C. for 30 minutes to be further polycondensated. After the polycondensation reaction of the raw material mixture was conducted in this way, the resin (liquid crystal polyester) in a molten state was taken out of the separable flask and cooled down to room temperature (25° C.), thereby obtaining a lump liquid crystal polyester (number average molecular weight (GPC): 115240). The evaluation results of the properties of the liquid crystal polyester thus obtained are shown in Table 1. Note that the result of the IR spectrometry of the liquid crystal polyester thus obtained is shown in FIG. 1. As is clear from the result of the IR spectrometry shown in FIG. 1, since the C═O stretching vibration of aromatic polyesters was observed at 1726 cm⁻¹, it was found that the obtained resin was a polyester resin (note that the C═O stretching vibration of aromatic amides was observed at 1672 cm⁻¹). In addition, since the spectrum exhibited a single peak in the result of the GPC measurement shown in FIG. 2, it was also found that the obtained resin was a resin having not a net-shaped structure but a dendrimer-type structure (dendrimer-type liquid crystal polyester) (note that in the graph of the GPC spectrum (the detector was a RI (refractometer)) shown in FIG. 2, the peak at 15.972 min indicates the peak of the resin, and the peak thereafter indicates the peak of NMP). Moreover, it was confirmed that the obtained liquid crystal polyester exhibited liquid crystallinity (which was a thermotropic liquid crystal), and it was also found that a portion of the polymer chain which became a branched chain had liquid crystallinity in the dendrimer-type liquid crystal polyester.

<Step of Preparing a Resin Solution>

After the lump liquid crystal polyester (dendrimer-type liquid crystal polyester) obtained as described above was crushed with a wooden hammer, NMP (16.0 g) was added to a powder (4.0 g) of the liquid crystal polyester, followed by heating at 100° C. for 2 hours to dissolve the powder to obtain a resin solution. Note that in such a resin solution, no solid component was visually observed. Since the liquid crystal polyester was completely dissolved in NMP, it was found that the liquid crystal polyester obtained as described above had solubility in a solvent.

<Step of Preparing a Film>

The resin solution obtained as described above was applied by spin-coating on the surface of a glass substrate [large-sized glass slide (manufactured by Matsunami Glass Ind., Ltd., trade name “S9213”, vertical side: 76 mm, horizontal side: 52 m, thickness: 1.3 mm)] such that the thickness of an applied film after heating became 22 μm, so that the applied film was formed on the glass substrate. Thereafter, the glass substrate with the applied film formed thereon was placed on a hot plate at 70° C. and left to stand for 0.5 hours to evaporate and remove the solvent from the applied film (solvent removal process). After such a solvent removal process was conducted, the glass substrate with the applied film formed thereon was placed into an inert oven (the flow rate of nitrogen: 5 L/min), was heated at a temperature condition of 80° C. for 0.5 hours under a nitrogen atmosphere, was subsequently heated at a temperature condition of 240° C. for 60 minutes, and was thereafter cooled down to 80° C. under a nitrogen atmosphere to obtain a polyester-coated glass in which the glass substrate was coated with a thin film made of polyester. Next, the polyester-coated glass thus obtained was immersed into a hot water at 90° C., and the polyester film was peeled off from the glass substrate to obtain a polyester film (a film having a size of a vertical side of 76 mm, a horizontal side of 52 mm, and a thickness of 22 μm). For the obtained polyester film, the evaluation results of dielectric property and the like are shown in Table 1.

### Examples 2 to 16

Liquid crystal polyesters were prepared, thereafter resin solutions were prepared, and subsequently polyester films were prepared, by employing the same steps as the “step of preparing a liquid crystal polyester”, the “step of preparing a resin solution”, and the “step of preparing a film” employed in Example 1 except that the types of the monomers (B) to (D) were changed to types shown in Table 1 or Table 2 and the amounts (molar amounts) of the monomers (A) to (D) used were changed to satisfy conditions of molar ratios shown in Table 1 or Table 2. Note that as is clear from the descriptions in Table 1 and Table 2, in Examples 1 to 12 and 14 to 16, the monomers were used such that the molar ratio of the monomers (A) to (C) (monomer (A):monomer (B):monomer (C)) became 1.5:1.0:1.0, and in Example 13, the monomers were used such that the molar ratio of the monomers (A) to (C) (monomer (A):monomer (B):monomer (C) became 2.0:1.0:1.0. The evaluation results and the like of the liquid crystal polyesters thus obtained are shown in Table 1 and Table 2. Note that like Example 1, as a result of conducting IR spectrometry, it was confirmed that all the obtained polymers were polyester.

### Comparative Example 1

A liquid crystal polyester was prepared, thereafter a resin solution was prepared, and subsequently a polyester film was prepared, by employing the same steps as the “step of preparing a liquid crystal polyester”, the “step of preparing a resin solution”, and the “step of preparing a film” employed in Example 1 except that the monomers (B) and (C) were changed to types shown in Table 2, no monomer (D) was used, and the amounts (molar amounts) of the monomers (A) to (C) used were changed to satisfy a condition of a molar ratio shown in Table 2, respectively. The evaluation results and the like of the liquid crystal polyester thus obtained are shown in Table 2.

### Comparative Example 2

A liquid crystal polyester was prepared, and thereafter preparation of a resin solution and a polyester film was attempted, by employing the same steps as the “step of preparing a liquid crystal polyester”, the “step of preparing a resin solution”, and the “step of preparing a film” employed in Example 1 except that the amount of the monomer (D) used was changed to satisfy a condition of a molar ratio shown in Table 2. However, in Comparative Example 2, the obtained liquid crystal polyester was not dissolved in NMP, so that no resin solution or polyester film was obtained. Hence, in Comparative Example 2, it was impossible to measure the permittivity and the dissipation factor. Note that in Comparative Example 2, the amount (addition proportion) of the monomer (D) added relative to 100 mol of the total amount of the monomers (A) to (C) was 14 mol as shown in Table 2. The evaluation results and the like of the obtained liquid crystal polyester are shown in Table 2.

### Comparative Example 3

A liquid crystal polyester was prepared, and thereafter preparation of a resin solution and a polyester film was attempted, by employing the same steps as the “step of preparing a liquid crystal polyester”, the “step of preparing a resin solution”, and the “step of preparing a film” employed in Example 1 except that the type of the monomer (B) was changed to IPA, the type of the monomer (C) was changed to MHQ, no monomer (D) was used, and the amounts (molar amounts) of the monomers (A) to (C) used were changed to satisfy a condition that the molar ratio of the monomers (monomer (A):monomer (B):monomer (C)) became 1.5:1.0:1.0. However, in Comparative Example 3, after the preparation of the resin solution, a solid component precipitated in the resin solution with the elapse of time (after the elapse of 12 hours), and the solubility in a solvent was not necessarily sufficient (note that in the resin solutions obtained in Examples 1 to 16, after the preparation of the resin solution, no solid component precipitated with the elapse of time, and the solubility in a solvent was higher). In this way, in Comparative Example 3, it was impossible to sufficiently dissolve the obtained resin in the solvent.

### Comparative Example 4

A liquid crystal polyester was prepared, and thereafter preparation of a resin solution and a polyester film was attempted, by employing the same steps as the “step of preparing a liquid crystal polyester”, the “step of preparing a resin solution”, and the “step of preparing a film” employed in Example 1 except that the type of the monomer (B) was changed to DCDPE, the type of the monomer (C) was changed to MHQ, no monomer (D) was used, and the amounts (molar amounts) of the monomers (A) to (C) were changed to satisfy a condition that the molar ratio of the monomers (monomer (A):monomer (B):monomer (C)) became 1.5:1.0:1.0. However, in Comparative Example 4, after the preparation of the resin solution, a solid component precipitated in the resin solution with the elapse of time (after the elapse of 12 hours), the solubility in a solvent was not necessarily sufficient. In this way, in Comparative Example 4, it was impossible to sufficiently dissolve the obtained resin in the solvent.

TABLE 1

| | | | | | Properties of the polyester | | | | | |
|---|---|---|---|---|---|---|---|---|---|---|
| | | | | | Number | | | | | |
| | | | | | average | | | | | |
| | The types and the contents of the monomers^{*1} | | | | molecular | | | Melting | Relative | Dissipation |
| | Monomer | Monomer | Monomer | Monomer | weight | Liquid | Solubility | point | permittivity | factor |
| | (A) | (B) | (C) | (D) | Mn (GPC) | crystallinity | to solvent | Tm (° C.) | Dk | Df |
| Example 1 | 2,6-HNA | 2,6-NDCA | 3-AP | 2,5-DHTPA | 115240 | Present | Present | 319 | 3.44 | 0.0024 |
| | (1.5) | (1.0) | (1.0) | (0.7 mol) | | | | | | |
| Example 2 | 2,6-HNA | 2,6-NDCA | 1,7-ANL | 2,5-DHTPA | 66320 | Present | Present | 304 | 3.26 | 0.0024 |
| | (1.5) | (10) | (1.0) | (0.7 mol) | | | | | | |
| Example 3 | 2,6-HNA | IPA | 4-AP | 2,5-DHTPA | 181350 | Present | Present | 285 | 3.65 | 0.0040 |
| | (1.5) | (1.0) | (1.0) | (0.7 mol) | | | | | | |
| Example 4 | 2,6-HNA | 2,6-NDCA | 3-AP | 2,5-DHTPA | Not | Present | Present | Not | 3.44 | 0.0034 |
| | (1.5) | (1.0) | (1.0) | (7 mol) | conducted | | | detected | | |
| Example 5 | 2,6-HNA | 2,6-NDCA | 3-AP | 1,5-DONDC | 121140 | Present | Present | 326 | 3.38 | 0.0024 |
| | (1.5) | (1.0) | (1.0) | (0.7 mol) | | | | | | |
| Example 6 | 2,6-HNA | 2,6-NDCA | 1,7-ANL | 1,5-DONDC | 91550 | Present | Present | 295 | 3.37 | 0.0027 |
| | (1.5) | (1.0) | (1.0) | (0.7 mol) | | | | | | |
| Example 7 | 2,6-HNA | IPA | MHQ | 2,5-DHTPA | 131220 | Present | Present | 285 | 3.30 | 0.0017 |
| | (1.5) | (1.0) | (1.0) | (1.0 mol) | | | | | | |
| Example 8 | 2,6-HNA | IPA | MHQ | 1,5-DONDC | 129070 | Present | Present | 290 | 3.48 | 0.0023 |
| | | (1.0) | (1.0) | (1.0 mol) | | | | | | |
| Example 9 | 2,6-HNA | IPA | MHQ | 1,3,5-BTCA | 116610 | Present | Present | 287 | 3.33 | 0.0018 |
| | (1.5) | (1.0) | (1.0) | (1.0 mol) | | | | | | |

^{*1}in Table 1 indicates that the values in parentheses of the monomers (A) to (C) are each a value of a molar ratio (monomer (A): monomer (B): monomer (C)) of the monomers, and that the values in parentheses of the monomer (D) are each a content (molar amount) of the monomer (D) relative to 100 mol (converted value) of the total molar amount of the monomers (A) to (C).

TABLE 2

| | | | | | Properties of the polyester | | | | | |
|---|---|---|---|---|---|---|---|---|---|---|
| | | | | | Number | | | | | |
| | | | | | average | | | | | |
| | The types and the contents of the monomers^{*1} | | | | molecular | | | Melting | Relative | Dissipation |
| | Monomer | Monomer | Monomer | Monomer | weight | Liquid | Solubility | point | permittivity | factor |
| | (A) | (B) | (C) | (D) | Mn (GPC) | crystallinity | to solvent | Tm (° C.) | Dk | Df |
| Example 10 | 2,6-HNA | IPA | MHQ | 5H-IPA | 116510 | Present | Present | 286 | 3.32 | 0.0020 |
| | (1.5) | (1.0) | (1.0) | (1.0 mol) | | | | | | |
| Example 11 | 2,6-HNA | IPA | MHQ | 3,5-DHBA | 112730 | Present | Present | 283 | 3.64 | 0.0020 |
| | (1.5) | (1.0) | (1.0) | (1.0 mol) | | | | | | |
| Example 12 | 2,6-HNA | IPA | MHQ | 1,3,5-BTOH | 111910 | Present | Present | 285 | 3.33 | 0.0019 |
| | (1.5) | (1.0) | (1.0) | (1.0 mol) | | | | | | |
| Example 13 | 2,6-HNA | IPA | MHQ | 5H-IPA | Not | Present | Present | 283 | 3.51 | 0.0015 |
| | (1.5) | (1.0) | (1.0) | (1.0 mol) | measured | | | | | |
| Example 14 | 2,6-HNA | IPA | MHQ | 2,5-DHTPA | Not | Present | Present | 301 | 3.31 | 0.0030 |
| | (1.5) | (1.0) | (1.0) | (1.0 mol) | measured | | | | | |
| Example 15 | 2,6-HNA | DCDPE | PhHQ | 2,5-DHTPA | 149770 | Present | Present | 281 | 3.35 | 0.0013 |
| | (1.5) | (1.0) | (1.0) | (1.0 mol) | | | | | | |
| Example 16 | 2,6-HNA | 2,6-NDCA | 6-Me-3-AP | 2,5-DHTPA | 108140 | Present | Present | 315 | 3.56 | 0.0025 |
| | (1.5) | (1.0) | (1.0) | (0.7 mol) | | | | | | |
| Comparative | 2,6-HNA | IPA | 4-AP | — | 168990 | Present | Present | 307 | 3.65 | 0.0042 |
| Example 1 | (1.5) | (1.0) | (1.0) | (Not used) | | | | | | |
| Comparative | 2,6-HNA | 2,6-NDCA | 3-AP | 2,5-DHTPA | Undetectable | Present | Absent | Not | Undetectable | Undetectable |
| Example 2 | (1.5) | (1.0) | (1.0) | (1.0 mol) | | | | detected | | |

^{*1}in Table 2 indicates that the values in parentheses of the monomers (A) to (C) are each a value of a molar ratio (monomer (A): monomer (B): monomer (C)) of the monomers, and that the values in parentheses of the monomer (D) are each a content (molar amount) of the monomer (D) relative to 100 mol (converted value) of the total molar amount of the monomers (A) to (C).

As is also clear from the ratios of the monomers shown in Table 1 and Table 2, the content of the “compound for forming a bent structural unit” in the raw material mixture used in each of Examples 1 to 16 was 29% by mol (Examples 1 to 12 and 14 to 16) or 25% by mol (Example 13), and the content proportion of the monomer (D) was 0.7 mol, 1.0 mol, or 7 mol relative to 100 mol of the monomers (A) to (C). Then, it was found that all the liquid crystal polyesters made of polycondensates of the raw material compounds formed in Examples 1 to 16 had solubility in a solvent and also the dissipation factor (Df) was such a low value as 0.0040 or less. From such results, it was found that the present invention made it possible to obtain a liquid crystal polyester that was capable of having a lower dissipation factor while being soluble in a solvent.

### Examples 17 to 32

First, the same resin solutions as the resin solutions prepared in the above-described Examples 1 to 16 were prepared by employing the same steps as the “step of preparing a liquid crystal polyester” and the “step of preparing a resin solution” employed in the above-described Examples 1 to 16. Next, polyester-coated copper foils were prepared as described below using the respective resin solutions thus obtained.

Specifically, each obtained resin solution was applied by spin-coating on the surface of a copper foil [a rolled copper foil manufactured by JX Nippon Mining & Metals Corporation (a copper foil having a surface treated with BHYX treatment) of 10 cm square having a thickness of 12 μm] such that the thickness of an applied film after heating became 10 μm, so that the applied film was formed on the copper foil. Thereafter, the copper foil with the applied film formed thereon was placed on a hot plate at 70° C. and was left to stand for 0.5 hours to evaporate and remove the solvent from the applied film (solvent removal process). After such a solvent removal process was conducted, the copper foil with the applied film formed thereon was placed into an inert oven (the flow rate of nitrogen: 5 L/min), was heated at a temperature condition of 80° C. for 0.5 hours under a nitrogen atmosphere, was then heated at a temperature condition of 240° C. for 60 minutes, and was thereafter cooled down to 80° C. under a nitrogen atmosphere to obtain a polyester-coated copper foil in which the copper foil was coated with a thin film made of polyester.

In this way, in Examples 17 to 32, polyester-coated copper foils were prepared respectively using the same resin solutions as the resin solutions prepared in Examples 1 to 16, and thereafter, the sticking force between the copper foil and polyester was evaluated using each of the obtained polyester-coated copper foils. Specifically, cuts (vertical and horizontal 11 directions, an interval of width of 1 mm) were made in the thin film made of polyester in the polyester-coated copper foil with a cutter knife, and thereafter a cross-cut test (grid tape test, commonly called: 100-square peeling test) was conducted using an adhesive tape [Cellotape (registered trademark) manufactured by Nichiban Co., Ltd.] to evaluate the sticking force between the copper foil and the polyester. As a result of such an evaluation test of sticking force, in all the polyester-coated copper foils obtained in Examples 17 to 32 (in which thin films of polyester were formed on copper foils using the same resin solutions as the resin solutions prepared in Examples 1 to 16), there was no peeling, lifting, or the like of the polyester at all, and it was thus confirmed that the sticking force between the copper foil and the polyester was significantly high. From such result, it was confirmed that when the resin solutions prepared in Examples 1 to 16 were used, the sticking force between the copper foil and the polyester became significantly high.

### INDUSTRIAL APPLICABILITY

As described above, the present invention makes it possible to provide a liquid crystal polyester that is capable of having a lower dissipation factor while being soluble in a solvent, and a method for producing the same, as well as, a resin solution, a metal-clad laminate and a method for producing a metal-clad laminate that use the liquid crystal polyester. Hence, the liquid crystal polyester of the present invention can be favorably used, for example, as a material for forming a substrate used in high frequency⋅high speed communication devices (millimeter-wave radars for automobiles, antennas for smartphones, and the like), a material for forming a substrate for substitution of resin substrates used in the existing FCCL, and the like.

1. A liquid crystal polyester wherein
a linear liquid crystal polymer chain comprising the following monomers (A) to (C):
[monomer (A)] a bifunctional aromatic hydroxycarboxylic acid;
[monomer (B)] a bifunctional aromatic dicarboxylic acid; and
[monomer (C)] at least one compound selected from the group consisting of a bifunctional aromatic diol and a bifunctional aromatic hydroxyamine, in which at least one of the monomer (B) and the monomer (C) contains a compound for forming a bent structural unit, and a content of the compound for forming a bent structural unit is 20 to 40% by mol relative to a total molar amount of the monomers (A) to (C), is bonded via the following monomer (D):
[monomer (D)] an aromatic compound having 3 to 8 functional groups of at least one kind selected from the group consisting of a hydroxy group, a carboxy group, and an amino group, and
a content proportion of the monomer (D) is 0.01 to 10 mol relative to 100 mol of the total molar amount of the monomers (A) to (C).

2. The liquid crystal polyester according to claim 1, wherein
the monomer (A) is at least one compound selected from compounds represented by the following formula (1):
HO—Ar¹—COOH (1)
[in the formula, Ar¹ is a group selected from the group consisting of 1,4-phenylene, 2,6-naphthylene, and 4,4′-biphenylene],
the monomer (B) is at least one compound selected from compounds represented by the following formula (2):
HOOC—Ar²—COOH (2)
[in the formula, Ar² is a group which may have at least one substituent selected from the group consisting of a fluorine atom, a chlorine atom, a bromine atom, a methyl group, an ethyl group, a propyl group, a trifluoromethyl group, and a phenyl group and which is selected from the group consisting of 1,4-phenylene, 1,3-phenylene, 1,4-naphthylene, 1,5-naphthylene, 1,7-naphthylene, 1,3-naphthylene, 1,6-naphthylene, 2,6-naphthylene, 2,7-naphthylene, and groups represented by the following formula (2-1): 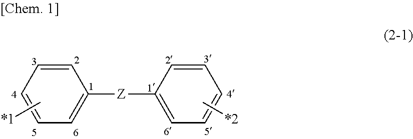
(in the formula, Z is a single bond or a group selected from the group consisting of groups represented by formulae: —O—, —O—(CH₂)₂—O—, —O—(CH₂)₆—O—, —C(CF₃)₂⁻, —CO—, and —SO₂—)],
the monomer (C) is at least one compound selected from compounds represented by the following formulae (3) to (4):
HO—Ar³—OH (3)
HO—Ar⁴—NH₂ (4)
[in the formula (3), Ar³ is a group which may have at least one substituent selected from the group consisting of a fluorine atom, a chlorine atom, a bromine atom, a methyl group, an ethyl group, a propyl group, a trifluoromethyl group, and a phenyl group and which is selected from the group consisting of 1,4-phenylene, 1,3-phenylene, 1,2-phenylene, 1,2-naphthylene, 1,4-naphthylene, 1,5-naphthylene, 1,7-naphthylene, 1,8-naphthylene, 2,3-naphthylene, 1,3-naphthylene, 1,6-naphthylene, 2,6-naphthylene, 2,7-naphthylene, and groups represented by the following formula (3-1): 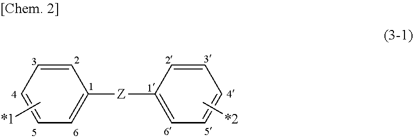
(in the formula, Z is a single bond or a group selected from the group consisting of groups represented by formulae: —O—, —CH₂—, —CH(CH₃)—, —C(CH₃)₂⁻, —C(CF₃)₂⁻, —CPh₂-, —CO—, —S—, and —SO₂—), and
in the formula (4), Ar⁴ is a group which may have at least one substituent selected from the group consisting of a fluorine atom, a chlorine atom, a bromine atom, a methyl group, an ethyl group, a propyl group, a trifluoromethyl group, and a phenyl group and which is selected from the group consisting of 1,4-phenylene, 1,3-phenylene, 3,3′-biphenylene, 4,4′-biphenylene, 1,4-naphthylene, 1,5-naphthylene, 1,7-naphthylene, 2,8-naphthylene, 1,3-naphthylene, 2,4-naphthylene, 1,6-naphthylene, 2,5-naphthylene, 2,6-naphthylene, and 2,7-naphthylene], and
the compound for forming a bent structural unit is at least one compound selected from the group consisting of
compounds represented by the formula (2) wherein Ar² is a group which may have at least one substituent selected from the group consisting of a fluorine atom, a chlorine atom, a bromine atom, a methyl group, an ethyl group, a propyl group, a trifluoromethyl group, and a phenyl group and which is selected from the group consisting of 1,3-phenylene, 1,7-naphthylene, 1,3-naphthylene, 1,6-naphthylene, groups represented by the formula (2-1) wherein the Z is a single bond and bonding arms represented by *1 and *2 are bonded to 3,4′ positions, 3,3′ positions, 3,2′ positions, or 2,2′ positions, and groups represented by the formula (2-1) wherein the Z is one selected from the group consisting of groups represented by formulae: —O—, —O—(CH₂)₂—O—, —O—(CH₂)₆—O—, —C(CF₃)₂, —CO—, and —SO₂—;
compounds represented by the formula (3) wherein Ar³ is a group which may have at least one substituent selected from the group consisting of a fluorine atom, a chlorine atom, a bromine atom, a methyl group, an ethyl group, a propyl group, a trifluoromethyl group, and a phenyl group and which is selected from the group consisting of 1,3-phenylene, 1,2-phenylene, 1,2-naphthylene, 1,7-naphthylene, 1,8-naphthylene, 2,3-naphthylene, 1,3-naphthylene, 1,6-naphthylene, 2,7-naphthylene, groups represented by the formula (3-1) wherein the Z is a single bond and bonding arms represented by *1 and *2 are bonded to 3,4′ positions, 3,3′ positions, 3,2′ positions, or 2,2′ positions, and groups represented by the formula (3-1) wherein the Z is one selected from the group consisting of groups represented by formulae: —O—, —CH₂—, —CH(CH₃)—, —C(CH₃)₂—, —C(CF₃)₂—, —CPh₂-, —CO—, —S—, and —SO₂—; and
compounds represented by the formula (4) wherein Ar⁴ is a group which may have at least one substituent selected from the group consisting of a fluorine atom, a chlorine atom, a bromine atom, a methyl group, an ethyl group, a propyl group, a trifluoromethyl group, and a phenyl group and which is selected from the group consisting of 1,3-phenylene, 1,7-naphthylene, 2,8-naphthylene, 1,3-naphthylene, 2,4-naphthylene, 1,6-naphthylene, 2,5-naphthylene, and 2,7-naphthylene.

3. The liquid crystal polyester according to claim 1, wherein
the content proportion of the monomer (D) is 0.1 to 5 mol relative to 100 mol of the total molar amount of the monomers (A) to (C).

4. A method for producing a liquid crystal polyester, comprising:
polycondensating a raw material mixture comprising the following monomers (A) to (D):
[monomer (A)] a bifunctional aromatic hydroxycarboxylic acid;
[monomer (B)] a bifunctional aromatic dicarboxylic acid;
[monomer (C)] at least one compound selected from the group consisting of a bifunctional aromatic diol and a bifunctional aromatic hydroxyamine; and
[monomer (D)] an aromatic compound having 3 to 8 functional groups of at least one kind selected from the group consisting of a hydroxy group, a carboxy group, and an amino group, in which at least one of the monomer (B) and the monomer (C) contains a compound for forming a bent structural unit, a content of the compound for forming a bent structural unit is 20 to 40% by mol relative to a total molar amount of the monomers (A) to (C), and a content proportion of the monomer (D) is 0.1 to 10 mol relative to 100 mol of the total molar amount of the monomers (A) to (C), to obtain a liquid crystal polyester in which a linear liquid crystal polymer chain comprising the monomers (A) to (C) is bonded via the monomer (D).

5. The method for producing a liquid crystal polyester according to claim 4, wherein
the monomer (A) is at least one compound selected from compounds represented by the following formula (1):
HO—Ar¹—COOH (1)
[in the formula, Ar¹ is a group selected from the group consisting of 1,4-phenylene, 2,6-naphthylene, and 4,4′-biphenylene],
the monomer (B) is at least one compound selected from compounds represented by the following formula (2):
HOOC—Ar²—COOH (2)
[in the formula, Ar² is a group which may have at least one substituent selected from the group consisting of a fluorine atom, a chlorine atom, a bromine atom, a methyl group, an ethyl group, a propyl group, a trifluoromethyl group, and a phenyl group and which is selected from the group consisting of 1,4-phenylene, 1,3-phenylene, 1,4-naphthylene, 1,5-naphthylene, 1,7-naphthylene, 1,3-naphthylene, 1,6-naphthylene, 2,6-naphthylene, 2,7-naphthylene, and groups represented by the following formula (2-1): 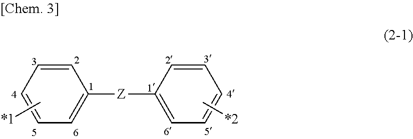
(in the formula, Z is a single bond or a group selected from the group consisting of groups represented by formulae: —O—, —O—(CH₂)₂—O—, —O—(CH₂)₆—O—, —C(CF₃)₂⁻, —CO—, and —SO₂—)],
the monomer (C) is at least one compound selected from compounds represented by the following formulae (3) to (4):
HO—Ar³—OH (3)
HO—Ar⁴—NH₂ (4)
[in the formula (3), Ar³ is a group which may have at least one substituent selected from the group consisting of a fluorine atom, a chlorine atom, a bromine atom, a methyl group, an ethyl group, a propyl group, a trifluoromethyl group, and a phenyl group and which is selected from the group consisting of 1,4-phenylene, 1,3-phenylene, 1,2-phenylene, 1,2-naphthylene, 1,4-naphthylene, 1,5-naphthylene, 1,7-naphthylene, 1,8-naphthylene, 2,3-naphthylene, 1,3-naphthylene, 1,6-naphthylene, 2,6-naphthylene, 2,7-naphthylene, and groups represented by the following formula (3-1): 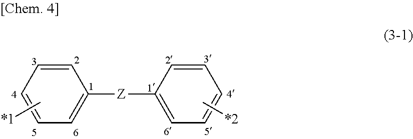
(in the formula, Z is a single bond or a group selected from the group consisting of groups represented by formulae: —O—, —CH₂—, —CH(CH₃)—, —C(CH₃)₂⁻, —C(CF₃)₂⁻, —CPh₂-, —CO—, —S—, and —SO₂—), and
in the formula (4), Ar⁴ is a group which may have at least one substituent selected from the group consisting of a fluorine atom, a chlorine atom, a bromine atom, a methyl group, an ethyl group, a propyl group, a trifluoromethyl group, and a phenyl group and which is selected from the group consisting of 1,4-phenylene, 1,3-phenylene, 3,3′-biphenylene, 4,4′-biphenylene, 1,4-naphthylene, 1,5-naphthylene, 1,7-naphthylene, 2,8-naphthylene, 1,3-naphthylene, 2,4-naphthylene, 1,6-naphthylene, 2,5-naphthylene, 2,6-naphthylene, and 2,7-naphthylene], and
the compound for forming a bent structural unit is at least one compound selected from the group consisting of
compounds represented by the formula (2) wherein Ar² is a group which may have at least one substituent selected from the group consisting of a fluorine atom, a chlorine atom, a bromine atom, a methyl group, an ethyl group, a propyl group, a trifluoromethyl group, and a phenyl group and which is selected from the group consisting of 1,3-phenylene, 1,7-naphthylene, 1,3-naphthylene, 1,6-naphthylene, groups represented by the formula (2-1) wherein the Z is a single bond and bonding arms represented by *1 and *2 are bonded to 3,4′ positions, 3,3′ positions, 3,2′ positions, or 2,2′ positions, and groups represented by the formula (2-1) wherein the Z is one selected from the group consisting of groups represented by formulae: —O—, —O—(CH₂)₂—O—, —O—(CH₂)₆—O—, —C(CF₃)₂, —CO—, and —SO₂—;
compounds represented by the formula (3) wherein Ar³ is a group which may have at least one substituent selected from the group consisting of a fluorine atom, a chlorine atom, a bromine atom, a methyl group, an ethyl group, a propyl group, a trifluoromethyl group, and a phenyl group and which is selected from the group consisting of 1,3-phenylene, 1,2-phenylene, 1,2-naphthylene, 1,7-naphthylene, 1,8-naphthylene, 2,3-naphthylene, 1,3-naphthylene, 1,6-naphthylene, 2,7-naphthylene, groups represented by the formula (3-1) wherein the Z is a single bond and bonding arms represented by *1 and *2 are bonded to 3,4′ positions, 3,3′ positions, 3,2′ positions, or 2,2′ positions, and groups represented by the formula (3-1) wherein the Z is one selected from the group consisting of groups represented by formulae: —O—, —CH₂—, —CH(CH₃)—, —C(CH₃)₂—, —C(CF₃)₂—, —CPh₂-, —CO—, —S—, and —SO₂—; and
compounds represented by the formula (4) wherein Ar⁴ is a group which may have at least one substituent selected from the group consisting of a fluorine atom, a chlorine atom, a bromine atom, a methyl group, an ethyl group, a propyl group, a trifluoromethyl group, and a phenyl group and which is selected from the group consisting of 1,3-phenylene, 1,7-naphthylene, 2,8-naphthylene, 1,3-naphthylene, 2,4-naphthylene, 1,6-naphthylene, 2,5-naphthylene, and 2,7-naphthylene.

6. A resin solution comprising:
the liquid crystal polyester according to claim 1; and
a solvent.

7. A metal-clad laminate comprising:
a metal foil; and
a polyester resin layer stacked on the metal foil, wherein
the polyester resin layer is a layer comprising the liquid crystal polyester according to claim 1.

8. A method for producing a metal-clad laminate, comprising:
forming an applied film of the resin solution according to claim 6 on a surface of a metal foil; and then
heating and curing the applied film to obtain a metal-clad laminate.
